(19) United States
(12) Patent Application Publication
(10) Pub. No.: US 2015/0022518 A1
(43) Pub. Date: Jan. 22, 2015

(54) IMAGE PROCESS DEVICE, IMAGE PROCESS METHOD, AND IMAGE PROCESS PROGRAM

(71) Applicant: JVC KENWOOD Corporation, Yokohama-shi (JP)

(72) Inventor: Hiroshi TAKESHITA, Hiratsuka-shi (JP)

(21) Appl. No.: 14/330,614

(22) Filed: Jul. 14, 2014

(30) Foreign Application Priority Data
Jul. 18, 2013 (JP) 2013-149137

(51) Int. Cl. G06T 15/20; H04N 13/00; G06T 5/20

(52) U.S. Cl. CPC G06T 15/205; G06T 5/20; H04N 13/0018; G06T 2207/20024; G06T 2207/20192
USPC 345/419

(57) ABSTRACT

In an image process device, a depth map generation unit generates a depth map of an input image on the basis of the input image and a depth model. A 3D image generation unit performs a pixel shift on the input image on the basis of the depth map so as to generate an image from a different viewpoint. In this process, the 3D image generation unit alpha-blends a pixel of the object that is moved by the pixel shift and a pixel that is covered by the pixel of the object.

### CROSS REFERENCE TO RELATED APPLICATION

This application is based upon and claims the benefit of priority from both the prior Japanese Patent Application No. 2013-149137, filed Jul. 18, 2013, the contents of which are incorporated herein by references.

### BACKGROUND OF THE INVENTION

1. Field of the Invention

The present invention relates to an image process device, an image process method, and an image process program, for executing a process of converting a 2D image into a 3D image for stereoscopic vision.

2. Description of the Related Art

In recent years, 3D video content items such as 3D movies or 3D broadcasting have been widespread. In order to allow an observer to perform stereoscopic vision, a right eye image and a left eye image with parallax are required. When a 3D video is displayed, a right eye image and a left eye image are displayed in a time-division manner, and the right eye image and the left eye image are separated using glasses for video separation such as shutter glasses or polarization glasses. Thereby, an observer can perform stereoscopic vision by observing the right eye image only with the right eye and the left eye image only with the left eye. In addition, if a right eye image and a left eye image are not temporally divided but spatially divided, glasses are not necessary but a resolution is reduced. In any of the glasses method and the glassless method, a right eye image and a left eye image are commonly necessary.

There are largely two methods of producing 3D images, that is, one is a method of simultaneously capturing a right eye image and a left eye image using two cameras, and the other is a method of generating a parallax image by editing a 2D image captured by a single camera afterward. The present invention relates to the latter and relates to a 2D-3D conversion technique.

FIG. 1 is a diagram illustrating a basic process procedure of 2D-3D conversion. First, a depth map (also referred to as depth information) is generated from a 2D input image (step S10). In addition, 3D images are generated using the 2D input image and the depth map (step S30). In FIG. 1, the 2D input image is set as a right eye image of the 3D output images, and an image obtained by shifting pixels of the 2D input image using the depth map is set as a left eye image of the 3D output images. Hereinafter, a set of a right eye image and a left eye image with predetermined parallax is referred to as 3D images or parallax images.

If 3D images are to be generated, pixels of a 2D image are shifted using a depth map, and a 2D image from a different viewpoint with parallax for the 2D image is generated. Omitted pixels occur in the generated 2D image from the different viewpoint due to the pixel shift. Generally, the omitted pixels are interpolated from peripheral pixels.

[Patent Document 1] Japanese Patent Application Publication H10-293390.

In a case where a step-difference in depths at an object boundary is large inside a screen, a pixel shift amount of the boundary part increases. Therefore, the number of omitted pixels, that is, the area of an omitted region also increases. As described above, the omitted pixels are interpolated from peripheral pixels; however, if the area of the omitted region increases, a location where an interpolated pixel does not match an interpolation position tends to occur.

### SUMMARY OF THE INVENTION

The present invention has been made in consideration of these circumstances, and an object thereof is to provide a technique for improving image quality of an object boundary part when 3D images are generated from a 2D image.

In order to addresses the aforementioned issue, an image process device is provided according to an aspect of the present invention. The device includes: a depth map generation unit configured to generate a depth map of an input image on the basis of the input image and a depth model; and an image generation unit configured to perform a pixel shift on the input image on the basis of the depth map so as to generate an image from a different viewpoint. The image generation unit alpha-blends a pixel of an object that is moved by the pixel shift and a pixel that is covered by the pixel of the object.

According to another aspect of the present invention, an image process method is provided. The method includes: generating a depth map of an input image on the basis of the input image and a depth model; and generating an image from a different viewpoint, by performing a pixel shift on the input image on the basis of the depth map. The generating of the image from a different viewpoint alpha-blends a pixel of an object that is moved by the pixel shift and a pixel that is covered by the pixel of the object.

According to yet another aspect of the invention, an image process device is provided. The device includes: a depth map generation unit configured to generate a depth map of an input image on the basis of the input image and a depth model; a pixel shift unit configured to perform a pixel shift on the input image on the basis of the depth map so as to generate an image from a different viewpoint; a mask shift unit configured to perform a pixel shift on a low-pass filtering mask on the basis of the depth map; and a filter unit configured to apply a low-pass filter to the generated image from a different viewpoint by using the shifted low-pass filtering mask.

In addition, any combination of above-described constituent elements, and expression of the present invention converted between a method, a device, a system, a recording medium, a computer program, and the like are also useful as aspects of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a diagram illustrating a basic process procedure of 2D-3D conversion;

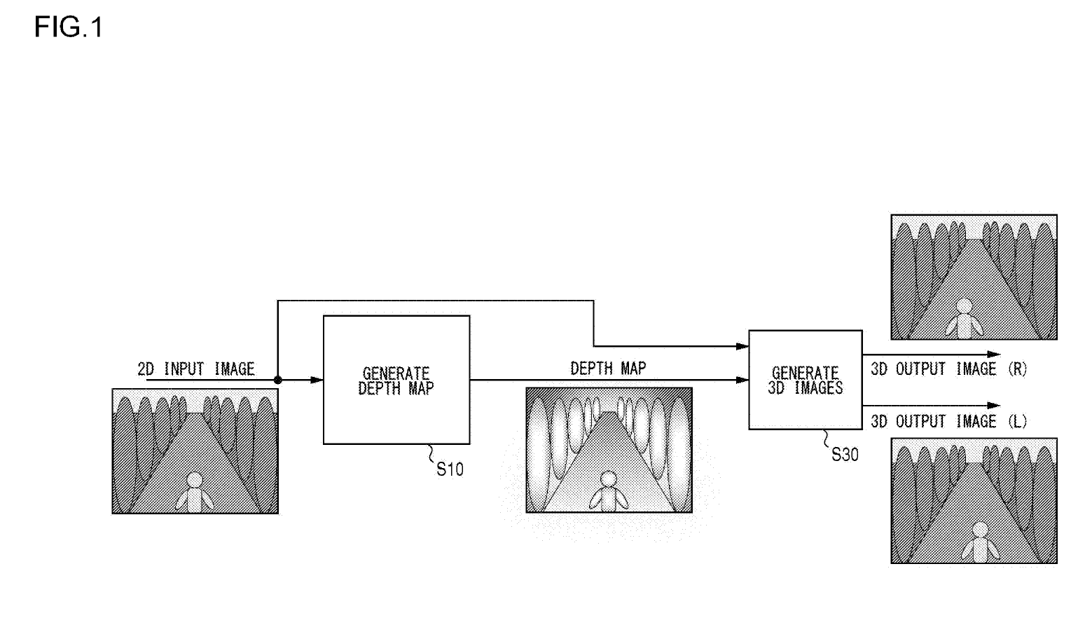

FIG. 2 is a diagram illustrating an image editing system according to a basic exemplary embodiment of the present invention;

FIG. 3 is a diagram illustrating a configuration example of the depth map generation unit according to an exemplary embodiment of the present invention;

FIG. 4 is a diagram illustrating overall process procedures of the image editing system according to the basic exemplary embodiment of the present invention;

FIG. 5 is a diagram illustrating a gain adjusting procedure of an input depth map;

FIG. 6 is a diagram illustrating an offset adjusting procedure of the input depth map;

FIG. 7 is a diagram illustrating a combining process procedure of layer depth maps;

FIG. 8 is a diagram illustrating a gain adjusting procedure of an input depth map in which a mask is not used;

FIG. 9 is a diagram illustrating an offset adjusting procedure of an input depth map in which a mask is not used;

FIG. 10 is a diagram illustrating pixel shift and pixel interpolation;

FIG. 11 is a diagram illustrating pixel shift and pixel interpolation in a case where a step-difference in depths of an object boundary is large;

FIG. 12 is a diagram illustrating pixel shift and pixel interpolation in which awkwardness does not occur even in a case where a step-difference in depths of an object boundary is large;

FIG. 13 is a diagram illustrating a configuration of an image editing system according to a first exemplary embodiment of the present invention;

FIG. 14 is a diagram illustrating overall process procedures of the image editing system according to the first exemplary embodiment of the present invention;

FIG. 15 is a diagram illustrating alpha-blending of layer depth maps;

FIG. 16 is a diagram illustrating a configuration example of the mask correcting unit;

FIG. 17 is a diagram illustrating a mask blurring process performed by the mask correcting unit of FIG. 16.

FIG. 18 is a diagram illustrating a relationship between a slant formed in a mask signal by a first low-pass filter and a first threshold value set in a binarization section;

FIG. 19 is a diagram illustrating a comparison between a slant given by the first low-pass filter and a slant given by the second low-pass filter;

FIG. 20 is a diagram illustrating overall process procedures of an image editing system according to a modified example of the first exemplary embodiment of the present invention;

FIG. 21 is a diagram illustrating a configuration example of the mask correcting unit according to the second exemplary embodiment of the present invention;

FIGS. 22A to 22C are diagrams illustrating a processing process of a mask edge using a second low-pass filter which is horizontally symmetrical;

FIGS. 23A to 23C are diagrams illustrating a processing process of a mask edge using a second low-pass filter which is horizontally asymmetrical;

FIG. 24 is a flowchart illustrating a process of determining a filter shape with a filter shape setting section according to the second exemplary embodiment of the present invention;

FIGS. 25A to 25C are diagrams illustrating a processing process of a mask edge using a first low-pass filter which is horizontally symmetrical;

FIGS. 26A to 26C are diagrams illustrating a processing process of a mask edge using a first low-pass filter which is horizontally asymmetrical;

FIG. 27 shows a foreground object before and after a pixel shift;

FIGS. 28A and 28B are diagrams for illustrating generation of 3D images using a pixel shift according to a common method;

FIGS. 29A and 29B are diagrams for illustrating generation of a 3D image using a pixel shift according to a third exemplary embodiment;

FIGS. 30A, 30B, 30C, and 30D are diagrams for illustrating basic processing of an object edge in a pixel shift;

FIGS. 31A, 31B, and 31C are diagrams for illustrating processing of an object edge in a pixel shift according to the first and second exemplary embodiments;

FIGS. 32A, 32B, and 32C are diagrams for illustrating processing of an object edge in a pixel shift according to the third exemplary embodiment;

FIGS. 33A and 33B show images schematically indicating a process of alpha-blending a foreground image and a background image;

FIG. 34 shows a configuration of an image process device according to the third exemplary embodiment of the present invention;

FIG. 35 shows a configuration of an image process device according to the fourth exemplary embodiment of the present invention; and

FIGS. 36A, 36B, 36C, 36D, 36E, 36F, and 36G are diagrams for illustrating a flow of generation of an image from a different viewpoint from an original image by the image process device according to the fourth exemplary embodiment.

### DETAILED DESCRIPTION OF THE INVENTION

The invention will now be described by reference to the preferred exemplary embodiments. This does not intend to limit the scope of the present invention, but to exemplify the invention.

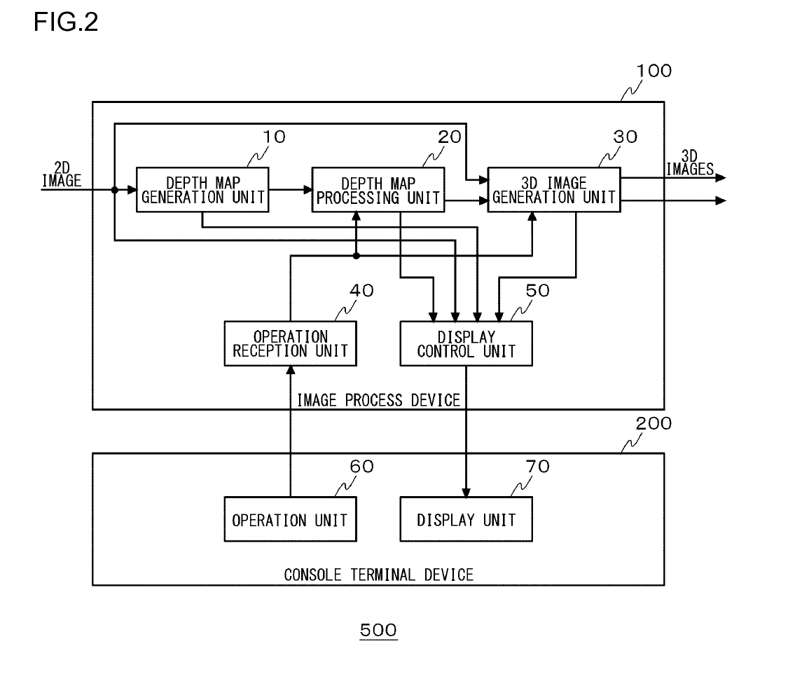

FIG. 2 is a diagram illustrating a configuration of an image editing system 500 according to a basic exemplary embodiment of the present invention. The image editing system 500 according to the present exemplary embodiment includes an image process device 100 and a console terminal device 200.

The console terminal device 200 is a terminal device used for an image producer (hereinafter referred to as a user) to produce and edit an image. The console terminal device 200 includes an operation unit 60 and a display unit 70. The operation unit 60 is an input device such as a keyboard or a mouse, and the display unit 70 is an output device such as a display. In addition, a touch panel display in which input and output are integrated may be used. Further, the console terminal device 200 may include a user interface such as a printer or a scanner which uses a printed matter as a medium. The operation unit 60 receives a user operation, generates a signal caused by the user operation, and outputs the signal to the image process device 100. The display unit 70 displays an image generated by the image process device 100.

The image process device 100 includes a depth map generation unit 10, a depth map processing unit 20, a 3D image generation unit 30, an operation reception unit 40, and a display control unit 50. This configuration can be implemented by any processor, memory, and other LSI in terms of hardware, and be implemented by a program or the like loaded to a memory in terms of software, and, here, a functional block realized by a combination thereof is drawn. Therefore, this functional block which can be realized by only hardware, only software, or a combination thereof can be understood by a person skilled in the art. For example, in relation to the depth map generation unit 10, the depth map processing unit 20, and the 3D image generation unit 30, overall functions thereof may be realized by software, and, functions of the depth map generation unit 10 and the 3D image generation unit 30 may be configured by a dedicated logic circuit, and a function of the depth map processing unit 20 may be realized by software.

The depth map generation unit 10 generates a depth map of a 2D image on the basis of the input 2D image and a depth model. The depth map is a grayscale image which indicates a depth value by a luminance value. The depth map generation unit 10 estimates a scene structure and generates a depth map by using a depth model suitable for the scene structure. In the present exemplary embodiment, the depth map generation unit 10 combines a plurality of basic depth models so as to be used to generate a depth map. At this time, a combining ratio of a plurality of basic depth models is varied depending on the scene structure of the 2D image.

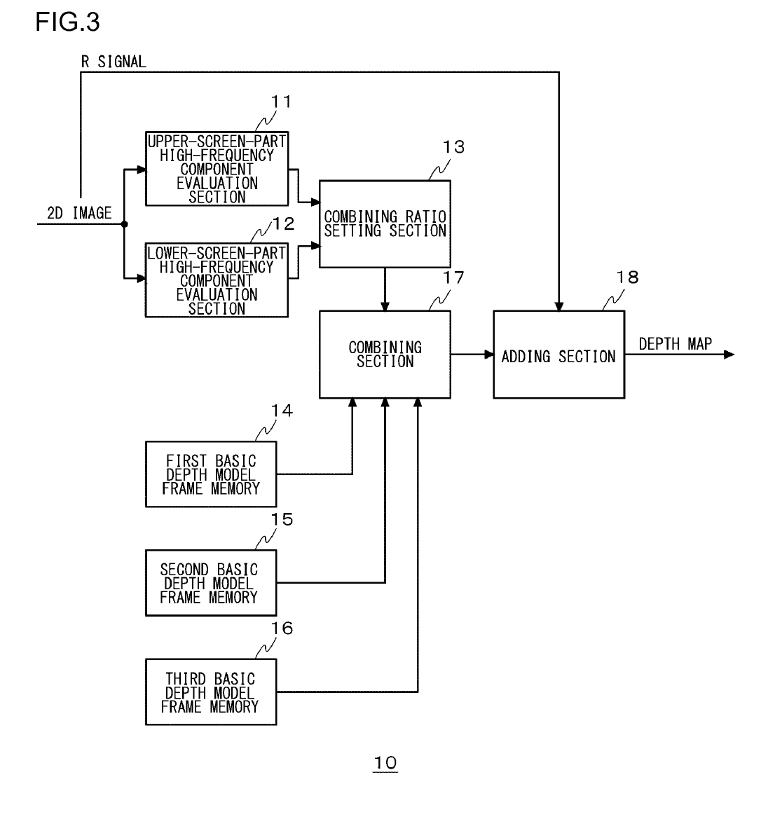

FIG. 3 is a diagram illustrating a configuration example of the depth map generation unit 10 according to the exemplary embodiment of the present invention. The depth map generation unit 10 includes an upper-screen-part high-frequency component evaluation section 11, a lower-screen-part high-frequency component evaluation section 12, a combining ratio setting section 13, a first basic depth model frame memory 14, a second basic depth model frame memory 15, a third depth model frame memory 16, a combining section 17, and an adding section 18.

The upper-screen-part high-frequency component evaluation section 11 calculates a ratio of pixels having a high frequency component in an upper screen part of a 2D image to be processed. The ratio is set as a high frequency component evaluation value of the upper screen part. In addition, a ratio of the upper screen part to the entire screen may be set to approximately 20%. The lower-screen-part high-frequency component evaluation section 12 calculates a ratio of pixels having a high frequency component in a lower screen part of the 2D image. The ratio is set as a high frequency component evaluation value of the lower screen part. In addition, a ratio of the lower screen part to the entire screen may be set to approximately 20%.

The first basic depth model frame memory 14 holds a first basic depth model, the second basic depth model frame memory 15 holds a second basic depth model, and the third basic depth model frame memory 16 holds a third basic depth model. The first basic depth model is a model with a spherical surface in which the upper screen part and the lower screen part are in a concave state. The second basic depth model is a model with a cylindrical surface in which the upper screen part has an axial line in the longitudinal direction, and with a spherical surface in which the lower screen part is in a concave state. The third basic depth model is a model with a plane on the upper screen part and with a cylindrical surface in which the lower screen part has an axial line in the transverse direction.

The combining ratio setting section 13 sets combining ratios k1, k2 and k3 (where k1+k2+k3=1) of the first basic depth model, the second basic depth model, and the third basic depth model, based on the high frequency component evaluation values of the upper screen part and the lower screen part which are respectively calculated by the upper-screen-part high-frequency component evaluation section 11 and the lower-screen-part high-frequency component evaluation section 12. The combining section 17 multiplies the combining ratios k1, k2 and k3 by the first basic depth model, the second basic depth model, and the third basic depth model, respectively, and adds the respective multiplication results to each other. This calculation result is a combined basic depth model.

For example, in a case where the high frequency component evaluation value of the upper screen part is small, the combining ratio setting section 13 recognizes a scene in which the sky or a flat wall is present in the upper screen part, and increases a ratio of the second basic depth model so as to increase the depth of the upper screen part. In addition, in a case where the high frequency component evaluation value of the lower screen part is small, a scene in which a flat ground or a water surface continuously extends in front in the lower screen part is recognized, and a ratio of the third basic depth model is increased. In the third basic depth model, the upper screen part is approximated to a plane as a distant view, and the lower screen part is gradually decreased in a depth toward the lower part.

The adding section 18 superimposes a red component (R) signal of the 2D image on the combined basic depth model generated by the combining section 17. The use of the R signal is based on the experimental rule that there is a high possibility that the magnitude of the R signal may conform to unevenness of a subject in circumstances in which the magnitude of the R signal is close to that of pure light and in a condition in which the brightness of a texture is not greatly different. In addition, the reason for red and warm color usages is that those colors are advancing colors and are recognized as being further in front than cool colors, and thereby a stereoscopic effect is emphasized.

The description will be continued with reference to FIG. 2. The depth map processing unit 20 processes the depth map generated by the depth map generation unit 10. In the present exemplary embodiment, the depth map processing unit 20 individually or independently processes depth maps generated by the depth map generation unit 10 for a plurality of respective regions designated by a plurality of externally set mask patterns (hereinafter simply referred to as masks). For example, processings such as a gain adjusting process, an offset adjusting process, and a gradation process are performed. A process by the depth map processing unit 20 will be described in detail later.

The 3D image generation unit 30 generates a 2D image from a different viewpoint based on the above-described 2D image and the depth maps processed by the depth map processing unit 20. The 3D image generation unit 30 outputs the 2D image of an original viewpoint and the 2D image from a different viewpoint as a right eye image and a left eye image.

Hereinafter, a description will be made of a detailed example in which a 2D image from a different viewpoint having parallax with a 2D image of an original viewpoint is generated using the 2D image and depth maps. In this detailed example, the 2D image from the different viewpoint of which a viewpoint is shifted to the left is generated when using a viewpoint in displaying the 2D image of the original viewpoint on a screen as a reference. In this case, when a texture is displayed as a near view with respect to an observer, a texture of the 2D image of the original viewpoint is moved to the left side of the screen by a predetermined amount, and, when the texture is displayed as a distant view with respect to the observer, the texture is moved to the right side of the screen by a predetermined amount.

A luminance value of each pixel of a depth map is set to Yd, a congestion value indicating the sense of protrusion is set to m, and a depth value indicating the stereoscopic effect is set to n. The 3D image generation unit 30 shifts a texture of the 2D image of the original viewpoint corresponding to a luminance value Yd to the left in order from a small value of the luminance value Yd for each pixel by a (Yd−m)/n pixel. In a case where a value of (Yd−m)/n is negative, the texture is shifted to the right by a (m−Yd)/n pixel. In addition, to the observer, a texture having a small luminance value Yd of the depth map is observed inside the screen, and a texture having a large luminance value Yd is observed in front of the screen. The luminance value Yd, the congestion value m, and the depth value n are values ranging from 0 to 255, and, for example, the congestion value m is set to 200, and the depth value n is set to 20.

In addition, more detailed description of generation of a depth map by the depth map generation unit 10 and generation of 3D images by the 3D image generation unit 30 is disclosed in JP-A Nos. 2005-151534 and 2009-44722 which were filed previously by the present applicant.

The operation reception unit 40 receives a signal input from the operation unit 60 of the console terminal device 200. The operation reception unit 40 outputs the input signal to the depth map processing unit 20 or the 3D image generation unit 30 depending on the content thereof. The display control unit 50 controls the display unit 70 of the console terminal device 200. Specifically, the display control unit 50 can display 2D input images, depth maps generated by the depth map generation unit 10, depth maps processed by the depth map processing unit 20, and 3D images generated by the 3D image generation unit 30.

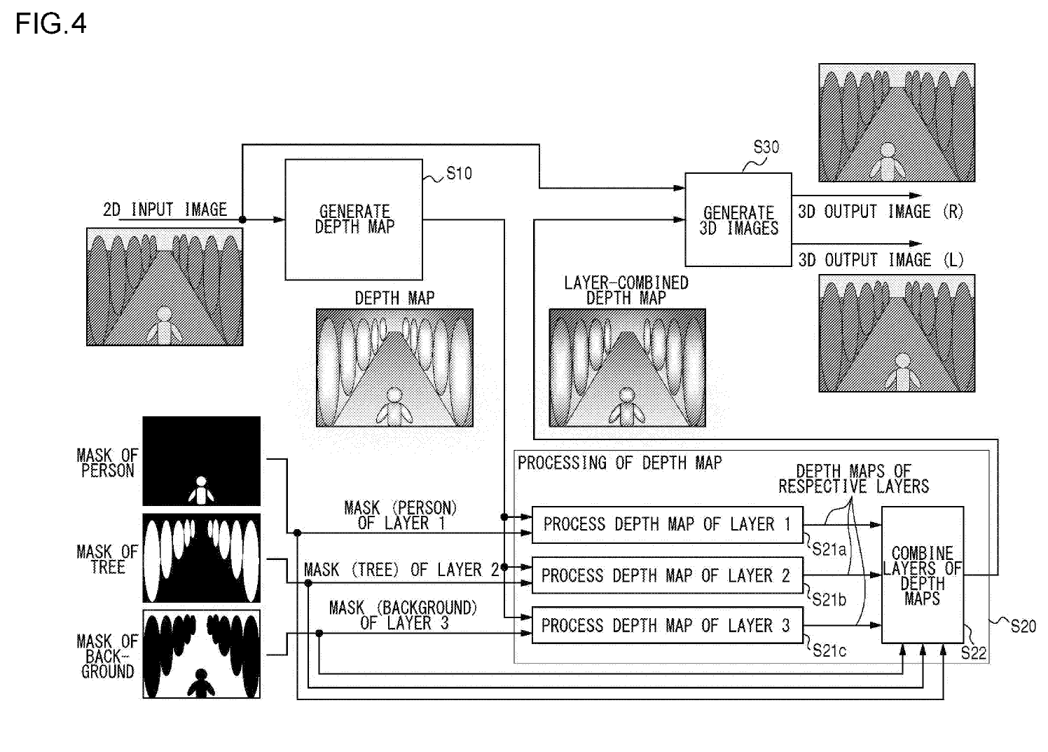

FIG. 4 is a diagram illustrating overall process procedures of the image editing system 500 according to a basic exemplary embodiment of the present invention. Generally, a 2D image includes a plurality of objects. The 2D input image of FIG. 4 includes three objects. Specifically, person, tree and background objects are included. First, the depth map generation unit 10 generates a depth map from the 2D input image (step S10). The depth map indicates that the closer to white, the higher the luminance and the shorter the distance from an observer, and the closer to black, the lower the luminance and the longer the distance from the observer. In a case of generating 3D images, a protrusion amount increases as much as a region close to white of the depth map, and a withdrawal amount increases as much as a region close to black.

In the present exemplary embodiment, in order to individually adjust the sense of depth for a plurality of objects in an image, an effect is independently adjusted for each object region in a depth map. Specifically, each object region is specified in a depth map using a plurality of masks indicating the respective object regions in the image. In addition, an effect is individually adjusted for each specified object region, and a plurality of effect-adjusted depth maps are obtained. Further, a single depth map is generated by combining the plurality of depth maps. The depth map is used to generate a 2D image from a different viewpoint from a 2D image of an original viewpoint.

The depth map generation unit 10 automatically generates a depth map of a 2D input image (S10). The generated depth map is input to the depth map processing unit 20. A plurality of masks which respectively indicate a plurality of object regions in the 2D input image are also input to the depth map processing unit 20. These masks are generated based on outlines of the object regions which are traced by the user. For example, the display control unit 50 displays the 2D input image on the display unit 70, and the user traces outlines of regions which are used as the object regions in the 2D input image by using the operation unit 60. The operation reception unit 40 generates outline information of each object region on the basis of a signal from the operation unit 60, and outputs the outline information to the depth map processing unit 20 as a mask. In addition, a mask may be read by the image process device 100 by a scanner reading an outline drawn on a printed matter by the user.

In FIG. 4, a valid region of each mask is drawn white and an invalid region is drawn black. The mask of a person is a pattern in which only a region of the person is valid, and the other regions are invalid. The mask of a tree is a pattern in which only a region of the tree is valid, and the other regions are invalid. The mask of a background is a pattern in which only a region of the background is valid, and the other regions are invalid.

The number of masks per screen is not limited, and the user may set any number thereof. In addition, an object region may be set to a region which is decided as a single object region by the user. For example, as illustrated in FIG. 4, a single object region may be set in a single person, and an object region may be set for each site of the person, and, further, for each part of the site. Particularly, in order to generate high quality 3D images, a plurality of object regions may be set in a single person, and a thickness or a position in a depth direction may be adjusted for each site, and, further, for each part of the site.

The depth map processing unit 20 processes the depth map (hereinafter, referred to as an input depth map) input from the depth map generation unit 10 by using a plurality of masks input via a user interface (S20). The depth map processing unit 20 individually processes the depth map for each region specified by each mask. Hereinafter, the process of the depth map for each region is referred to as a layer process. In addition, a layer-processed depth map is referred to as a layer depth map. In the present specification, the layer is used as a concept indicating the unit of a process on a valid region of a mask.

In FIG. 4, as an example, the depth map processing unit 20 specifies a region of the person from the input depth map by using a mask of the person (a mask of a layer 1), thereby performing the layer process (S21a). Similarly, a region of the tree is specified from the input depth map by using a mask of the tree (a mask of a layer 2), thereby performing the layer process (S21b). Similarly, a region of the background is specified from the input depth map by using a mask of the background (a mask of a layer 3), thereby performing the layer process (S21c).

The depth map processing unit 20 combines the depth maps of the respective object regions of the layer depth maps of the layers 1 to 3 (S22). This depth map obtained through the combination is referred to as a combined depth map. The 3D image generation unit 30 shifts pixels of the 2D input image by using the combined depth map, and generates an image having parallax with the 2D input image (S30). The 3D image generation unit 30 outputs the 2D input image as a right eye image (R) of 3D output images and the generated image as a left eye image (L).

First, an example of adjusting a gain will be described as the layer process by the depth map processing unit 20. The gain adjustment is a process for adjusting a thickness of an object in the depth direction. If a gain increases, an object is thickened, and, if the gain decreases, the object is thinned.

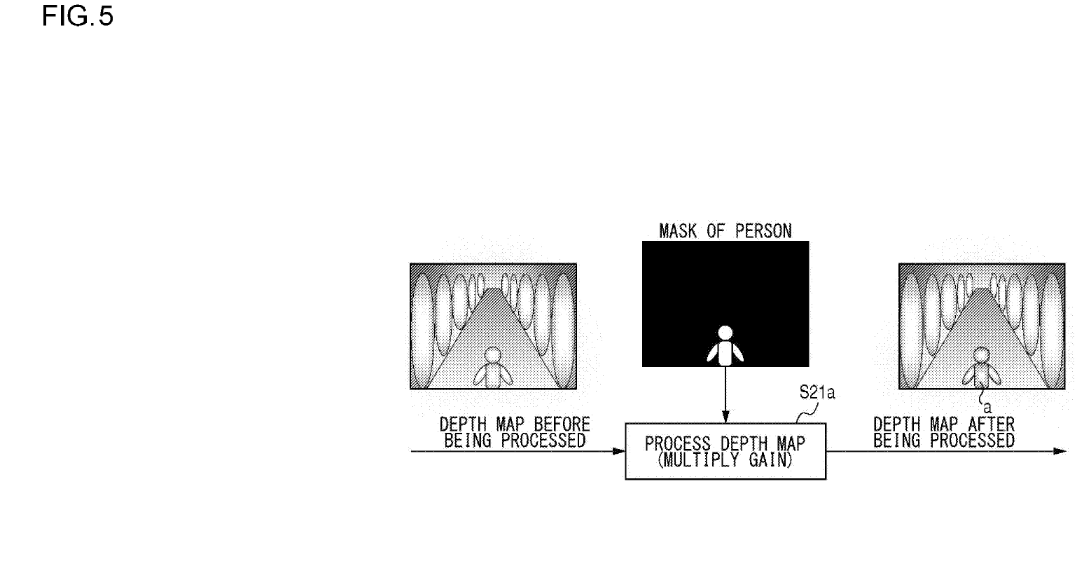

FIG. 5 is a diagram illustrating a gain adjusting procedure of an input depth map. The depth map processing unit 20 multiplies a gain only by the valid region of the mask of the person in the input depth map which is a depth map before being processed, thereby increasing the amplitude of a depth value of only the person part of the input depth map (S21a). In FIG. 5, the amplitude of the person part increases in the layer depth map which is a depth map after being processed (refer to the reference sign a).

Next, an example of adjusting an offset will be described as the layer process by the depth map processing unit 20. The offset adjustment is a process for adjusting a position of an object in the depth direction. If a positive offset value is added, an object is moved in a direction in which the object protrudes, and, if a negative offset value is added, the object is moved in a direction in which the object withdraws.

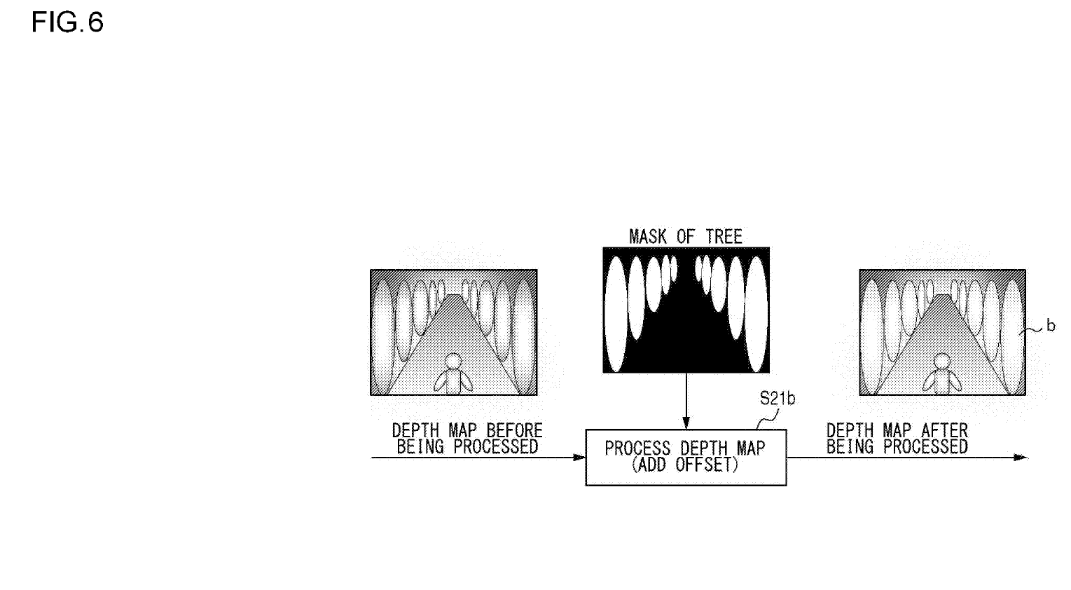

FIG. 6 is a diagram illustrating an offset adjusting procedure of the input depth map. The depth map processing unit 20 adds an offset to only the valid region of the mask of the tree in the input depth map which is a depth map before being processed, thereby increasing a level of a depth value of the tree part in the input depth map (S21b). In FIG. 6, a level of the tree part increases in the layer depth map which is a depth map after being processed (refer to the reference sign b).

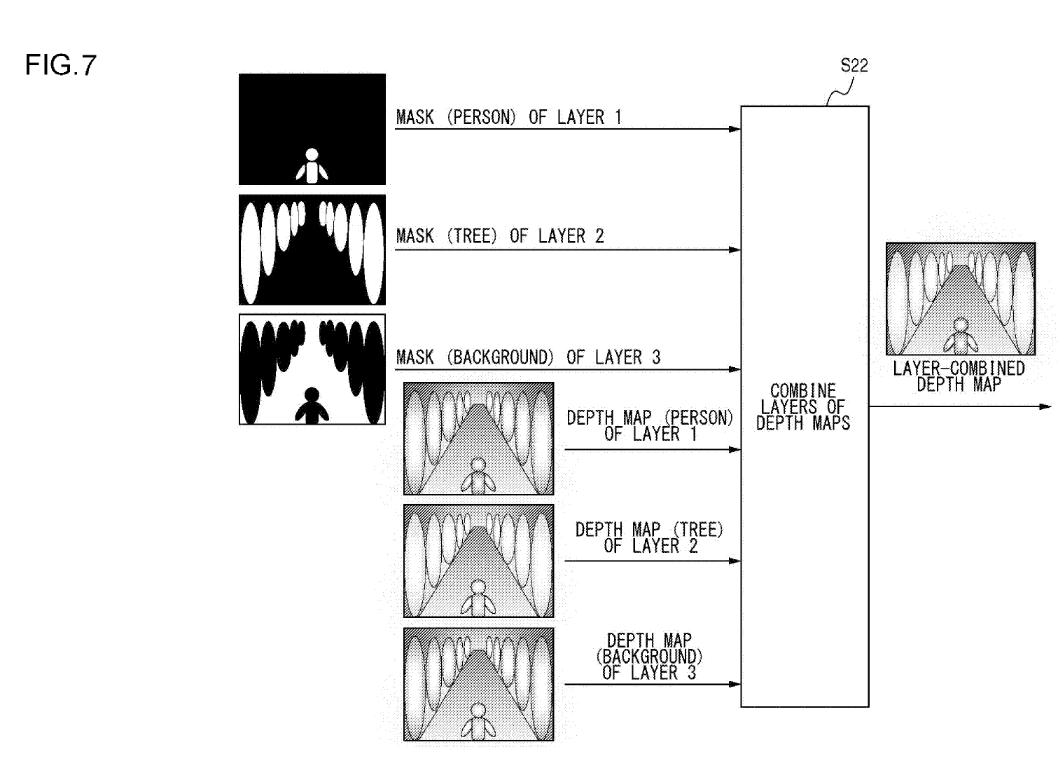

FIG. 7 is a diagram illustrating a combining process procedure of layer depth maps. The depth map processing unit 20 cuts only a valid region of the mask (the mask of the person) of the layer 1 from the layer depth map of the layer 1 (a depth map of the person). Similarly, only a valid region of the mask (the mask of the tree) of the layer 2 is cut from the layer depth map of the layer 2 (a depth map of the tree). Similarly, only a valid region of the mask (the mask of the background) of the layer 3 is cut from the layer depth map of the layer 3 (a depth map of the background). The depth map processing unit 20 combines the three cut depth maps so as to generate a combined depth map.

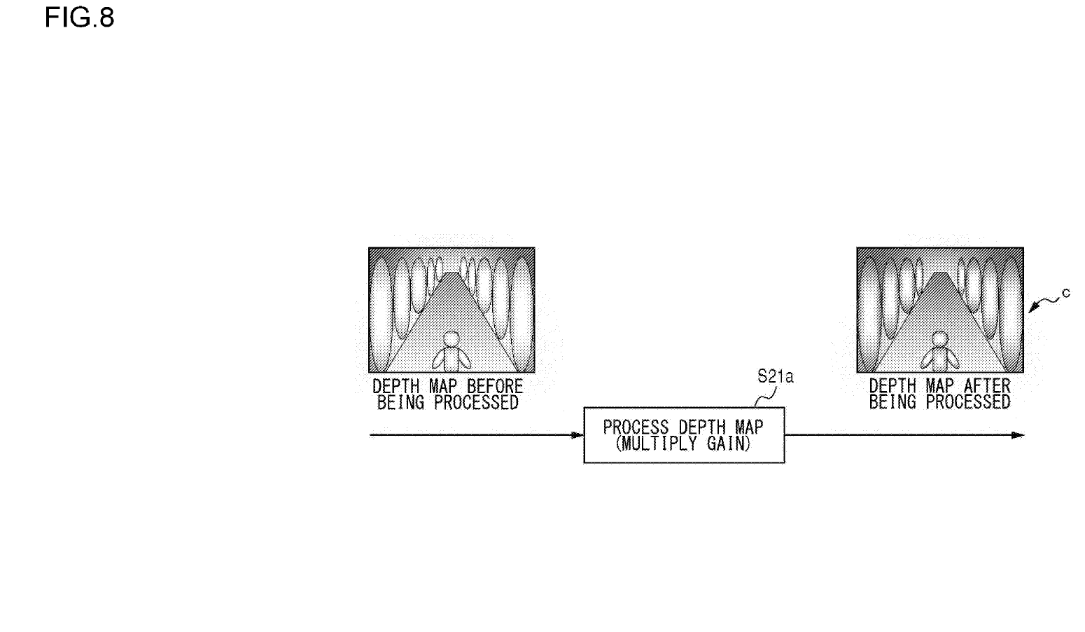

FIG. 8 is a diagram illustrating a gain adjusting procedure of an input depth map in which a mask is not used. When the layer depth maps are combined, if only a valid region of a mask of each layer depth map is used, an invalid region of the mask of each layer depth map is not reflected on a combined depth map. Therefore, the depth map processing unit 20 multiplies a gain by the entire input depth map so as to increase the amplitude of a depth value of the entire input depth map (S21a). In FIG. 8, the amplitude of the entire layer depth map increases (refer to the reference sign c).

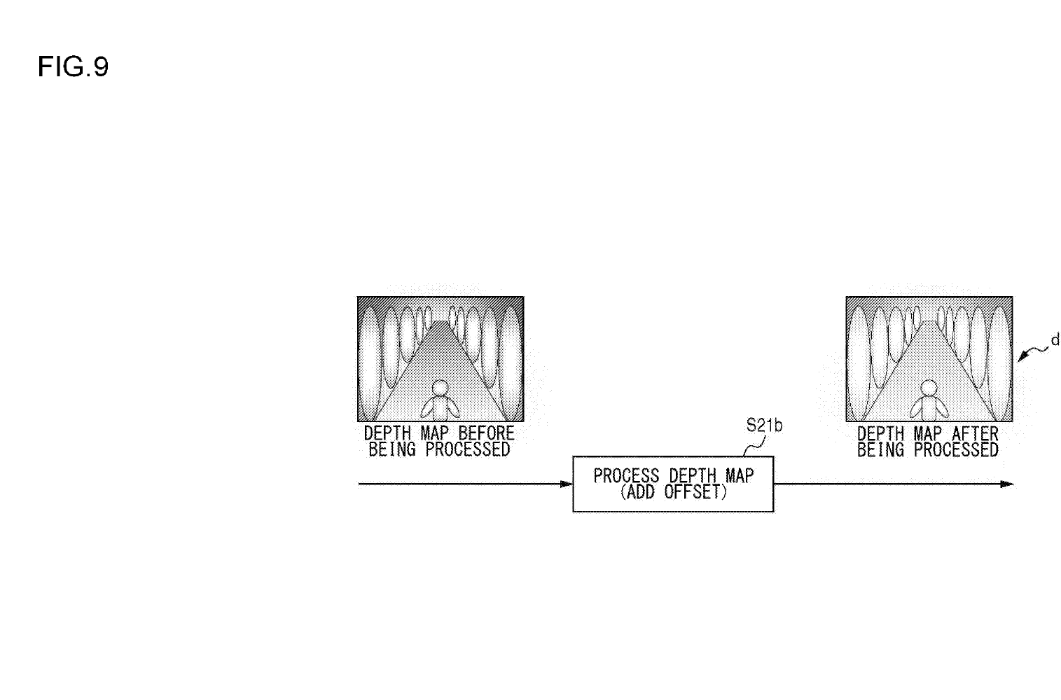

FIG. 9 is a diagram illustrating an offset adjustment procedure of an input depth map in which a mask is not used. When the layer depth maps are combined, if only a valid region of a mask of each layer depth map is used, an invalid region of the mask of each layer depth map is not reflected on a combined depth map. Therefore, the depth map processing unit 20 adds an offset to the entire input depth map so as to increase the level of a depth value of the entire input depth map (S21b). In FIG. 9, the level of the entire layer depth map increases (refer to the reference sign d).

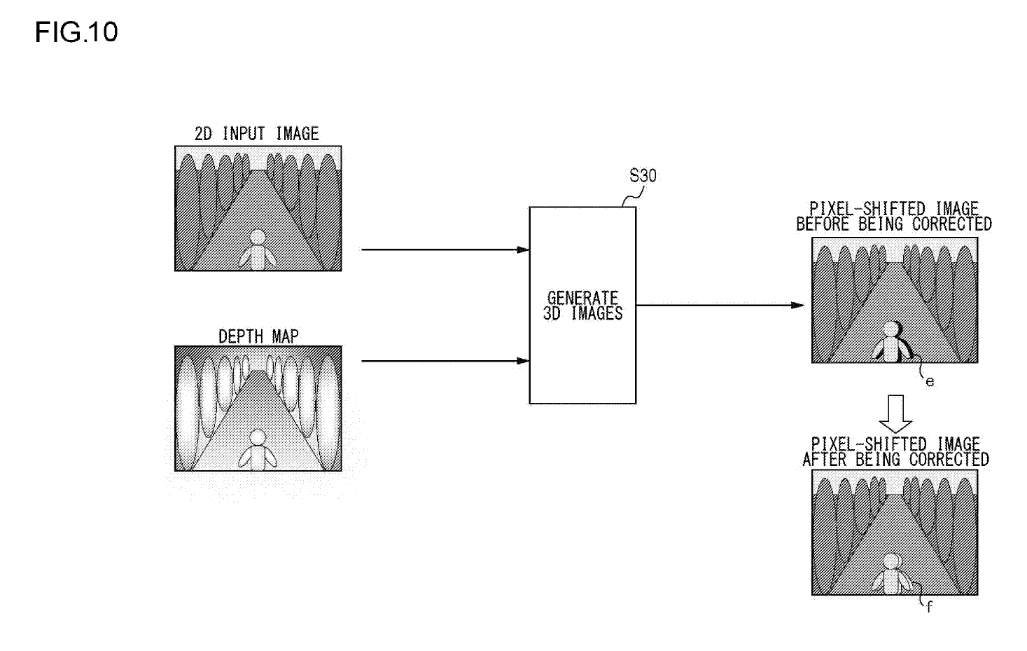

FIG. 10 is a diagram illustrating pixel shift and pixel interpolation. The 3D image generation unit 30 shifts pixels of a 2D input image on the basis of a combined depth map and generates an image having parallax with the 2D input image (S30). FIG. 10 illustrates an example in which pixels of a person region in a 2D input image are shifted to the left. In the depth map of FIG. 10, an offset value is added to a depth value of the person region, and thus the depth value of the person region increases. If the depth value of the person region increases, a protrusion amount of the person region of 3D images increases.

When the pixels of only the person region are shifted without shifting the pixels of the peripheral background region of the person region, an omitted pixel region with no pixels may occur (refer to the reference sign e of the pixel-shifted image before being corrected). The 3D image generation unit 30 interpolates the omitted pixel region using pixels generated from peripheral pixels, thereby correcting the omitted pixel region. There are various methods for pixel interpolation, and, for example, the interpolation is performed using pixels in the boundary of the person region (refer to the reference sign f of the pixel-shifted image after being corrected).

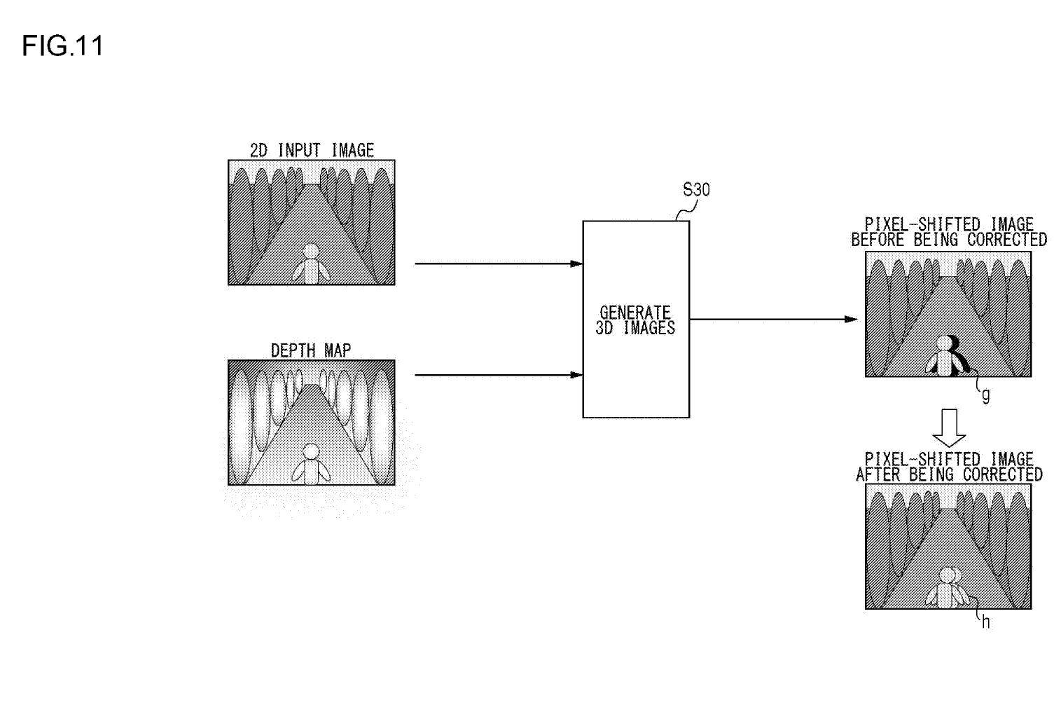

FIG. 11 is a diagram illustrating pixel shift and pixel interpolation in a case where a step-difference in depths of an object boundary is large. In a case where a step-difference in depths of an object boundary is large, a pixel shift amount also increases, and thus the area of an omitted pixel region increases accordingly. When the omitted pixel region is interpolated using pixels generated from peripheral pixels, the area of an interpolated region also increases, and, thus, awkwardness, mismatch, and incompatibility of an image are visible in the object boundary.

In FIG. 11, a pixel shift amount of the person region becomes larger than in FIG. 10. The area of the omitted pixel region of the pixel-shifted image before being corrected in FIG. 11 is larger than the area in FIG. 10 (refer to the reference sign g). In the same manner as the pixel-shifted image after being corrected in FIG. 10, the omitted pixel region is also interpolated using pixels of the boundary of the person region in the pixel-shifted image after being corrected in FIG. 11. The omitted pixel region is a region which is originally a background region, and, if the region increases, a shape of the person is destroyed (refer to the reference sign h).

In addition, there is an object with a clear boundary and there is an object with an unclear boundary in the image. The unclear boundary of the object is caused by, for example, defocus at the time of photographing, camera shaking, motion blur, and the like. In a case where an object boundary is unclear and vague, it is difficult to create an appropriate mask conforming to the object boundary. When processing of a depth map, pixel shift, and pixel interpolation are performed using a mask created with an incorrect outline, an outline of an object of a generated 3D image tends to be awkward.

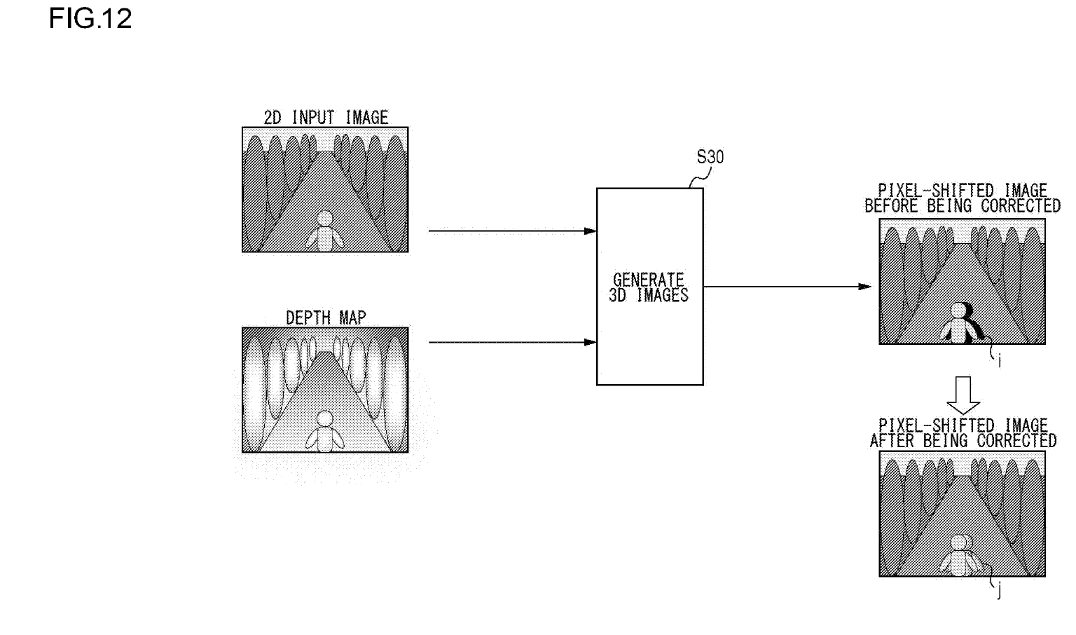

FIG. 12 is a diagram illustrating pixel shift and pixel interpolation in which awkwardness does not occur even in a case where a step-difference in depths of an object boundary is large. Despite the area of an omitted pixel region being large in the object boundary, interpolation is performed such that the person and the background smoothly change, and thereby awkwardness of the object boundary may become hardly visible.

The area of the omitted pixel region of the pixel-shifted image before being corrected in FIG. 12 is also larger than the area in FIG. 10 in the same manner as in FIG. 11 (refer to the reference sign i). In the pixel-shifted image after being corrected in FIG. 12, awkwardness in the boundary between the person and the background can be hardly visible unlike in the pixel-shifted image after being corrected in FIG. 11 (refer to the reference sign j).

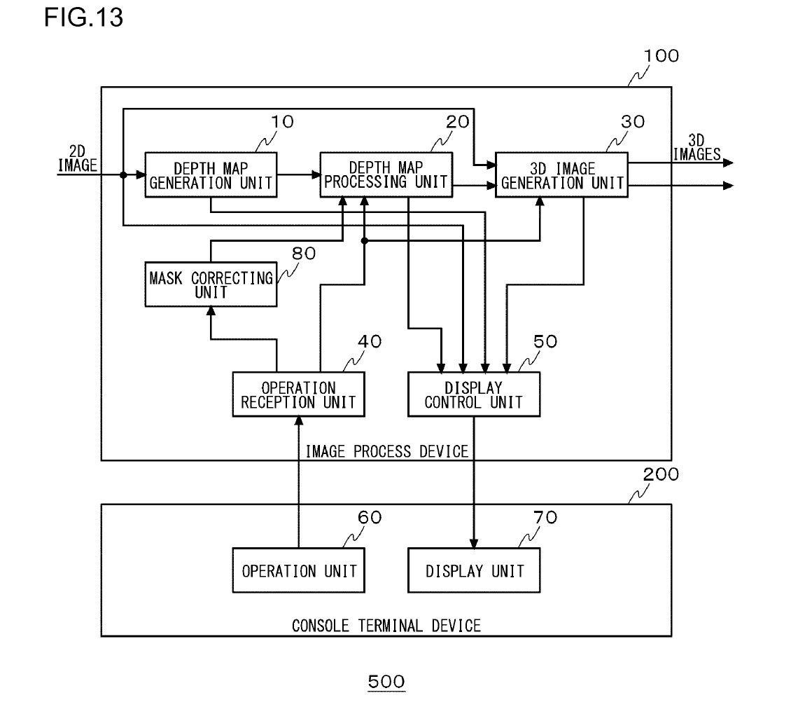

FIG. 13 is a diagram illustrating a configuration of an image editing system 500 according to the first exemplary embodiment of the present invention. In the image editing system 500 according to the first exemplary embodiment, a mask correcting unit 80 is added to the image process device 100 of the image editing system 500 according to the basic exemplary embodiment of FIG. 2. Hereinafter, a description will be made of a difference between the image editing system 500 according to the first exemplary embodiment of FIG. 13 and the image editing system 500 according to the basic exemplary embodiment of FIG. 2.

The mask correcting unit 80 corrects a mask set from the console terminal device 200 via the operation reception unit 40 and outputs the corrected mask to the depth map processing unit 20. Specifically, the mask correcting unit 80 performs a blurring process on an object boundary of the mask. The depth map processing unit 20 alpha-blends depth maps of a plurality of object regions, generated based on the masks corrected by the mask correcting unit 80. In other words, the depth map processing unit 20 combines a plurality of layer depth maps according to coefficients (a values) defined in the respective masks.

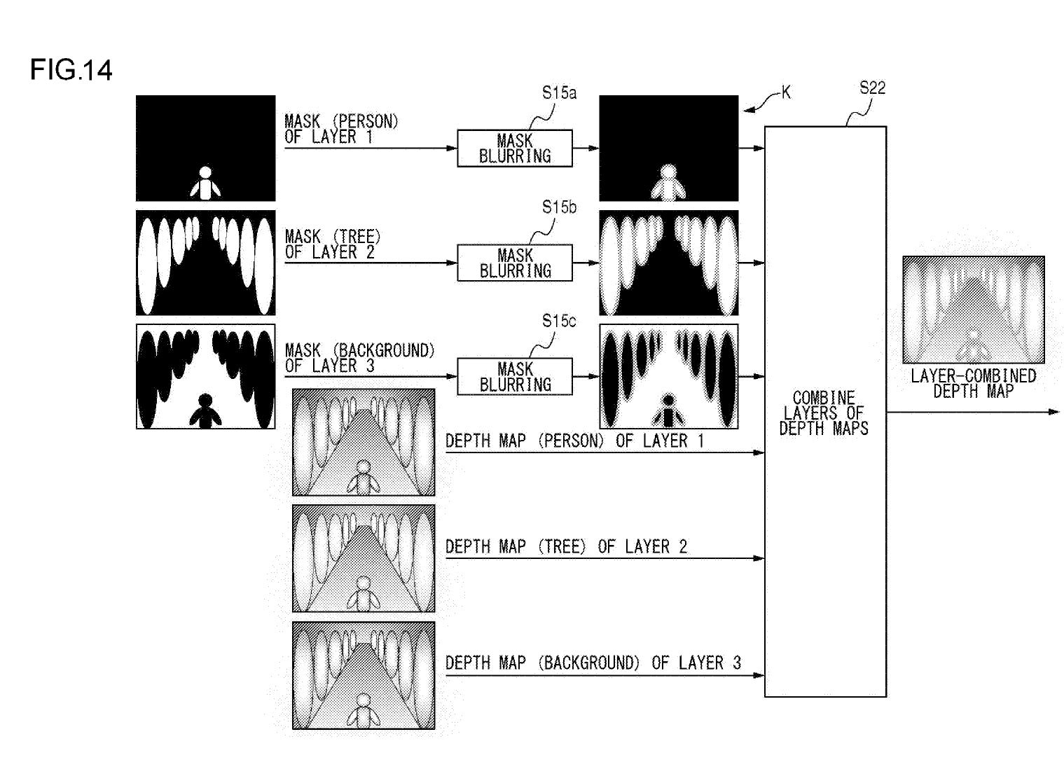

FIG. 14 is a diagram illustrating overall process procedures of the image editing system 500 according to the first exemplary embodiment of the present invention. The process procedure of FIG. 14 includes a mask blurring process added to the process procedure of FIG. 4. Hereinafter, a difference therebetween will be described. In addition, in the following description, a pixel value in a valid region (drawn white in the figure) of a mask is set to 1, and a pixel value in an invalid region (drawn black in the figure) is set to 0.

In the first exemplary embodiment, the mask of the layer 1 (the mask of the person), the mask of the layer 2 (the mask of the tree), and the mask of the layer 3 (the mask of the background) which are output from the operation reception unit 40 are input to the mask correcting unit 80 before being input to the depth map processing unit 20. The mask correcting unit 80 performs a mask blurring process on the object boundary part of each mask (S15a to S15c). Specifically, the mask correcting unit 80 corrects values of an edge (that is, a boundary between 0 and 1) and a peripheral region thereof (hereinafter both of them are collectively referred to as an edge region) of a mask signal to values between 0 and 1 (0 and 1 are excluded) (refer to the reference sign k).

The depth map processing unit 20 combines layer depth maps according to levels of the corrected masks (S22). Thereby, it is possible to generate a combined depth map in which a depth value is smoothly varied in the edge region of the mask. The 3D image generation unit 30 performs pixel shift and pixel interpolation using the combined depth map. Thereby, the object boundary is gently varied, and thus awkwardness of the object boundary is not visible.

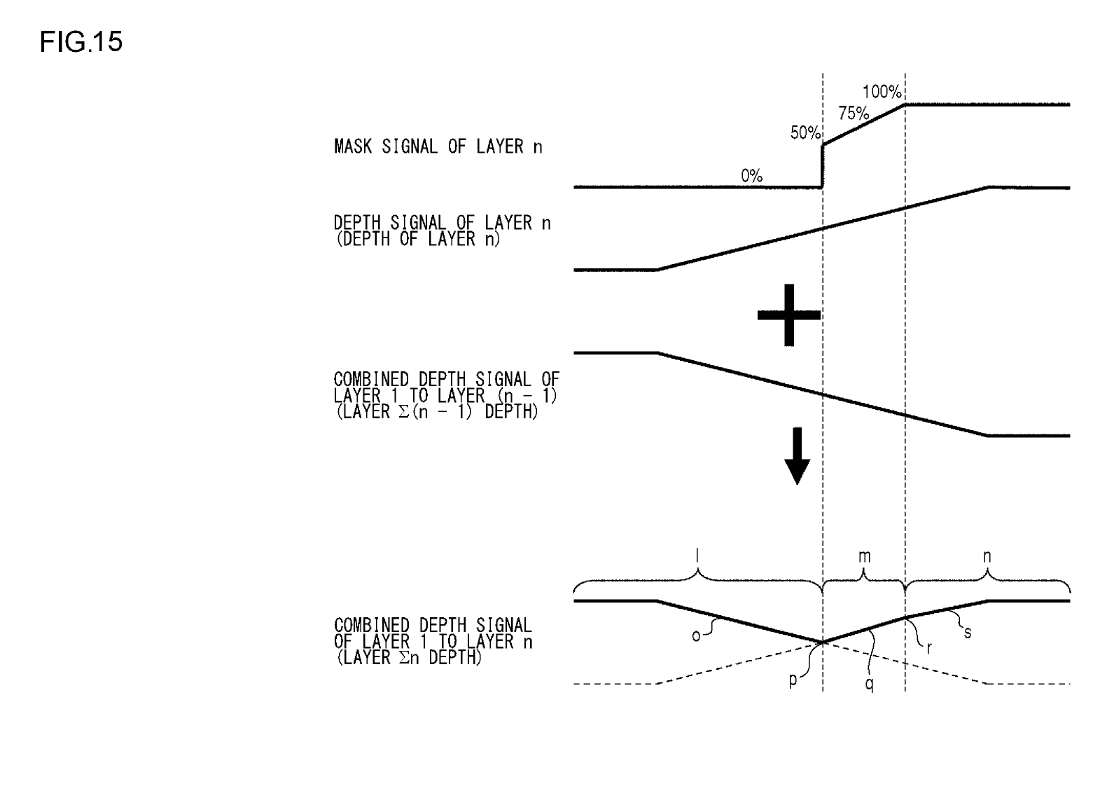

FIG. 15 is a diagram illustrating alpha-blending of layer depth maps. The depth map processing unit 20 determines a blending ratio of depth values of the respective layer depth maps on the basis of the values of the mask signals corrected by the mask correcting unit 80. The respective layer depth maps are superimposed in a designated order. The order to be superimposed is input by the user from the operation unit 60, and is set in the depth map processing unit 20 via the operation reception unit 40. In the example of the present specification, the layer depth map of the background, the layer depth map of the tree, and the layer depth map of the person are superimposed in this order.

In FIG. 15, an edge region of a mask signal of a layer n (where n is a natural number) includes a vertical rising edge from 0% to 50% and a gentle slant from 50% to 100%. The numerical value of each percentage indicates a combining ratio. Using the mask signal of the layer n, a depth signal of the layer n (hereinafter, referred to as a layer n depth) is blended with a combined depth signal of a layer Σ(n−1) (hereinafter, referred to as a layer Σ(n−1) depth). The layer Σ(n−1) depth is a combined depth signal obtained by blending depth signals from the layer 1 to the layer (n−1), that is, a combined depth signal which is generated up to a time point when the layer n depth is blended.

During a period (refer to the reference sign 1) when a combining ratio of the mask signal of the layer n is 0%, the layer n depth of 0% is blended with the layer Σ(n−1) depth of 100%. That is to say, the layer Σ(n−1) depth is not overwritten by the layer n depth, and the layer Σ(n−1) depth is output as it is (refer to the reference sign o). At the time point when a combining ratio of the mask signal of the layer n is 50% (refer to the reference sign p), the layer n depth of 50% is blended with the layer Σ(n−1) depth of 50%.

During the period when a combining ratio of the mask signal of the layer n is 50% to 100% (refer to the reference sign m), the layer n depth is blended with the layer Σ(n−1) depth whilst the combining ratio varies. For example, at the time point when a combining ratio of the mask signal of the layer n is 75% (refer to the reference sign q), the layer n depth of 75% is blended with the layer Σ(n−1) depth of 25%. The layer n depth of 100% is blended with the layer Σ(n−1) depth of 0% from the time point (refer to the reference sign r) when a combining ratio of the mask signal of the layer n reaches 100%. During the period (refer to the reference sign n) when a combining ratio of the mask signal of the layer n is 100%, the layer Σ(n−1) depth is completely overwritten by the layer n depth, and, as a result, the layer n depth is output as it is (refer to the reference sign s). Thereby, a layer Σn depth is generated. The layer Σn depth is a combined depth signal obtained by blending depth signals from the layer 1 to the layer n.

In addition, the mask signal of the layer Σ(n−1) depth is not used when the layer depths are blended. A combining ratio of the layer Σn depth and the layer Σ(n−1) depth is determined only by the mask signal of the layer Σn depth. Therefore, in a region where the layer depths overlap much, a depth value of a lower layer depth decreases as layer depths overlap.

Hereinafter, a process of blurring an edge of a mask signal will be described in detail. This blurring process includes the following three basic steps. First, an edge of an original mask signal is moved so as to be appropriately positioned for an outline of a target object. Thereby, the area of the object boundary of the mask is enlarged or reduced. Next, a slant is given to the edge of the mask. Finally, the edge region of the mask given the slant is limited.

Hereinafter, a description will be made of a method in which the above-described blurring process is performed using a low-pass filter. First, a low-pass filter is applied to a mask where a level of a black part is 0 and a level of a white part is 1. Thereby, it is possible to generate a mask where a slant of an intermediate level between 0 and 1 is given to the edge region without varying a level of a flat part.

Further, there are cases where a slant is desired to be given to only outside of a valid region of a mask and a level before being processed is desired to be maintained inside thereof in the edge region of the mask. In addition, conversely, there are cases where a slant is desired to be given to only the inside of the valid region of the mask and a level before being processed is desired to be maintained in the outside thereof in the edge region of the mask. In consideration of these cases, a process of moving the edge of the mask signal to any position by enlarging or reducing the valid region of the mask is inserted into a front stage of a low-pass filter for generating a blurring mask.

In addition, a process of limiting the blurred edge region is inserted into a rear stage of the low-pass filter for generating a blurring mask in order to prevent the edge of the mask from being enlarged more than an intended amount through the blurring process. Hereinafter, the blurring process using the low-pass filter will be described more in detail.

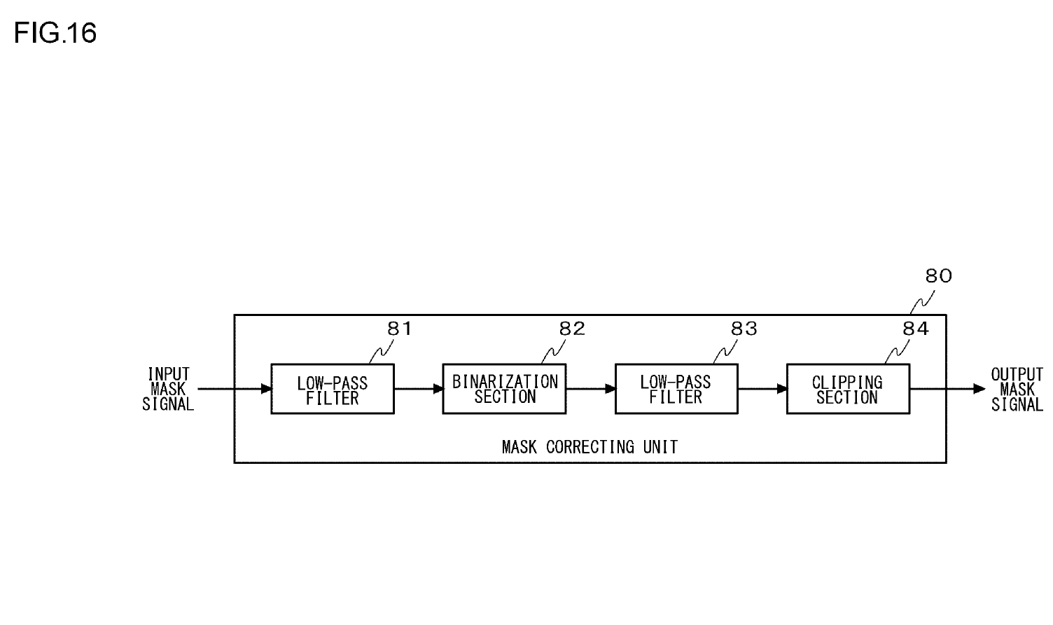

FIG. 16 is a diagram illustrating a configuration example of the mask correcting unit 80. The mask correcting unit 80 includes a first low-pass filter 81, a binarization section 82, a second low-pass filter 83, and a clipping section 84. This configuration can also be realized in various forms by only hardware, only software, or a combination thereof.

The first low-pass filter 81 in the first stage applies a low-pass filter to an original mask signal. The binarization section 82 binarizes a mask signal which is output from the first low-pass filter 81 and where the slant is given to the edge, using a first threshold value. A position of an edge of the original mask signal is moved through the operations of the first low-pass filter 81 and the binarization section 82.

The second low-pass filter 83 in the second stage applies a low-pass filter to the mask signal which is output from the binarization section 82 and where the position of the edge is moved. Thereby, a slant is given to the edge of the mask signal. The clipping section 84 clips the signal which is equal to or less than a second threshold value to 0, in the mask signal which is output from the second low-pass filter 83 and where the slant is given to the edge, using the second threshold value.

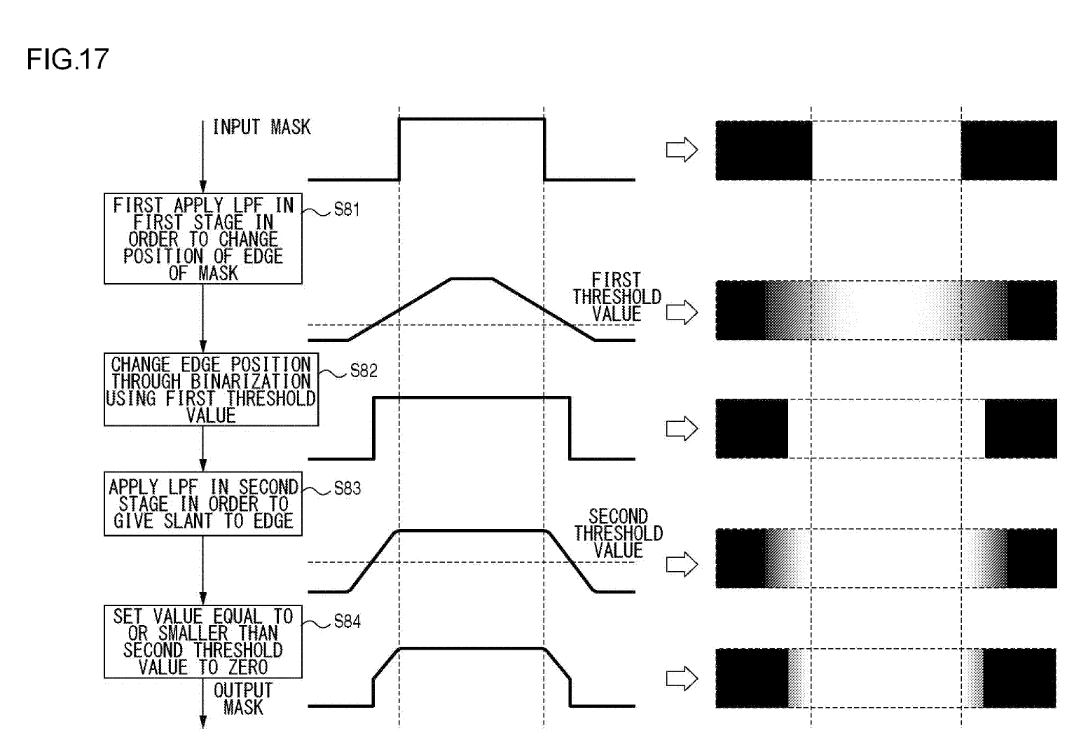

FIG. 17 is a diagram illustrating a mask blurring process performed by the mask correcting unit 80 of FIG. 16. In FIG. 17, a process flow is illustrated on the left, waveforms of mask signals are illustrated at the center, and mask images are illustrated on the right. In a description of FIG. 17, it is assumed that each pixel value of the mask is defined to 8 bits, black is defined to 0 (0b00000000) and white is defined to 255 (0b11111111) in the mask image. Typically, an original mask signal is a binary signal having only 0 or 255.

The original mask signal is input to the first low-pass filter 81. The first low-pass filter 81 applies a low-pass filter to the original mask signal as a pre-process for changing a position of the edge of the mask signal (S81). Specifically, the first low-pass filter 81 processes the original mask signal into a mask signal where an edge region slants. A value of the slanting part is processed into a value between 0 and 255 (excluding 0 and 255).

Next, the binarization section 82 compares the value of the mask signal which is processed as a pre-process for changing a position of the edge of the mask signal with the first threshold value, thereby binarizing the mask signal (S82). Specifically, if the value of the mask signal is larger than the first threshold value, the value of the mask signal is set to 255, and, if smaller, the value of the mask signal is set to 0. Thereby, the mask signal becomes a binary signal having only 0 or 255 again.

In a case where the first threshold value is set to be smaller than 127 which is an intermediate value between 0 and 255, the edge of the binarized mask signal is moved further outward than the edge of the original mask signal. In this case, the area of white in the mask image is enlarged. On the other hand, in a case where the first threshold value is set to be larger than 127 which is an intermediate value, the edge of the binarized mask signal is moved further inward than the edge of the original mask signal. In this case, the area of white in the mask image is reduced. In addition, in a case where the first threshold value is set to 127 which is an intermediate value, the edge of the binarized mask signal is located at the same position as the edge of the original mask signal.

FIG. 17 illustrates an example in which a position of the edge of the mask signal is moved outward. It is possible to arbitrarily adjust a position of the edge of the mask signal by varying filter characteristics such as the number of taps or coefficients of the first low-pass filter 81 and the first threshold value of the binarization section 82.

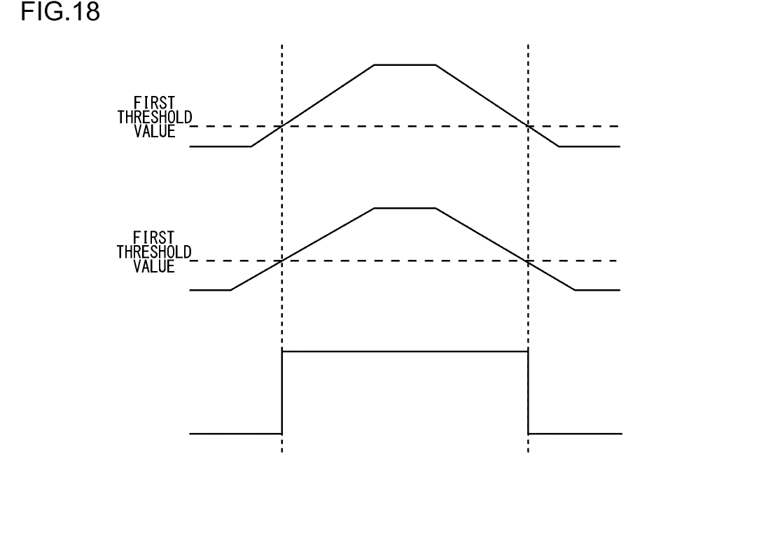

FIG. 18 is a diagram illustrating a relationship between a slant formed in a mask signal by the first low-pass filter 81 and the first threshold value set in the binarization section 82. In a case of generating mask signals having the same edge position, there is a relationship in which, if a slant is gentle and long, the first threshold value increases, and, if a slant is steep and short, the first threshold value decreases. The user inputs the filter characteristics of the first low-pass filter 81 and the first threshold value of the binarization section 82 from the operation unit 60 so as to be set in the first low-pass filter 81 and the binarization section 82 via the operation reception unit 40. The user adjusts at least one of the filter characteristics of the first low-pass filter 81 and the first threshold value of the binarization section 82 from the operation unit 60, thereby arbitrarily adjusting an edge position of the mask signal. In addition, since the first threshold value set to be low enables a slant to be short, the number of taps of the first low-pass filter 81 can be reduced, and thus the first low-pass filter 81 can be simplified.

The description will be continued with reference to FIG. 17 again. The mask signal where the edge position is moved is input to the second low-pass filter 83. The second low-pass filter 83 applies a low-pass filter to the mask signal where the edge position is moved (S83). Thereby, a blurring mask where the edge region slants again is generated.

Next, the clipping section 84 compares a value of the mask signal which is generated by the second low-pass filter 83 and has a slant in the edge region with the second threshold value, and sets the value of the mask signal to 0 when the value of the mask signal is equal to or smaller than the second threshold value (S84). In other words, the slant on the white side is left and the slant on the black side steeply falls in the edge region. Thereby, the slant varying from white to gray can be given in the region larger than the second threshold value, and the black mask can be generated in the region which is equal to or smaller than the second threshold value. Through this clipping process, a blurred region in the mask is limited, and thereby it is possible to suppress the edge region of the mask from increasing more than an intended size.

Although an example in which the blurring process is performed in the horizontal direction is illustrated in FIG. 17, a two-dimensional low-pass filter is used, and thereby the blurring process can be performed in both the horizontal direction and the vertical direction. At this time, a filter in which coefficients are different in the horizontal direction and the vertical direction may be used. In this case, an edge position of a mask signal, an extent of a slant, a blurring width can be adjusted individually in the horizontal direction and the vertical direction.

In addition, an elliptical two-dimensional low-pass filter which has different coefficients in the horizontal direction and the vertical direction and has an intermediate value of the horizontal and vertical coefficients in the slant direction may be used. If the elliptical two-dimensional low-pass filter is used, an edge position of a mask signal, an extent of a slant, and a blurring width can be adjusted individually in the horizontal direction and the vertical direction, and the adjustment can be applied to the slant direction. For example, a square original mask can be processed into a rectangular mask with any length in the horizontal direction and vertical direction and with round corners. In addition, a square original mask can be processed into a rectangular mask, given any gentle slant in all directions, in which extents of horizontal and vertical slants gently vary with continuity with extents of horizontal and vertical slants at corners in an individual and arbitrary manner.

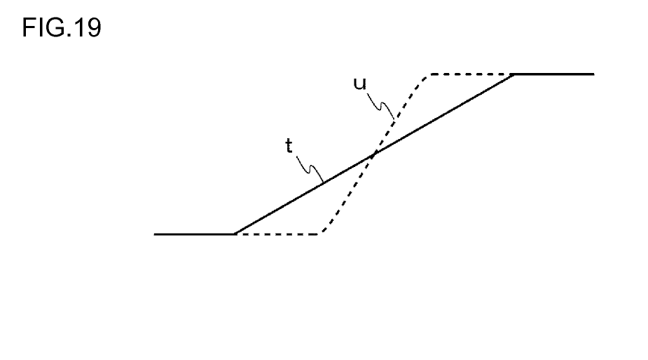

FIG. 19 is a diagram illustrating a comparison between a slant given by the first low-pass filter 81 and a slant given by the second low-pass filter 83. The slant given by the first low-pass filter 81 (refer to the reference sign t) is a false slant used to adjust a binarization boundary position, and disappears after the binarization. Therefore, the slant may be a slant which linearly varies at a constant angle. The slant (refer to the reference sign t) given by the second low-pass filter 83 is a remaining slant, and thus the user may also adjust a shape of the slant. For example, the slant may be adjusted to a shape of which an upper part is convex on an upper side of the slant, and a lower part is convex on a lower side thereof. If the adjustment to this shape is performed, a clipped width can be increased.

As such, by adjusting the filter characteristics such as the number of taps or coefficients of the first low-pass filter 81 and the second low-pass filter 83, the first threshold value of the binarization section 82, and the second threshold value of the clipping section 84, it is possible to freely adjust an edge position of a mask signal, the area of a valid region of a mask, and a blurring width. In addition, it is not necessary to perform the same blurring process on mask signals of all layers, and the blurring process may be performed individually for each mask signal of a layer.

Through the above-described blurring process, an edge of a mask signal can be moved to any position, and the area of a valid region of the mask can be varied. In addition, any slant can be given to an edge region. Further, any limitation is imposed on a blurring region of a mask.

The blurring mask is used to combine depth maps in a subsequent stage. The depth map processing unit 20 alpha-blends a plurality of layer depth maps according to a level of the blurring mask. At this time, a combining ratio of the layer depth maps is determined depending on the level of the blurring mask.

As described above, according to the first exemplary embodiment, when the layer depth maps are combined, the blurring mask is used, and thereby continuity can be given to an object boundary part of a combined depth map. In other words, in a case where a great step-difference is in the object boundary part, the step-difference can be reduced. Therefore, an object boundary part of an image from a different viewpoint generated based on the combined depth map can be completed to a natural boundary.

In addition, even in a case where a mask created with an incorrect outline is used for an object of which a boundary is vague, a position of the outline is adjusted, and thereby it is possible to prevent an outline of an object of a generated 3D image from being an awkward outline.

Hereinafter, a description will be made of a method in which awkwardness of an object boundary can be hardly visible without using a blurring mask.

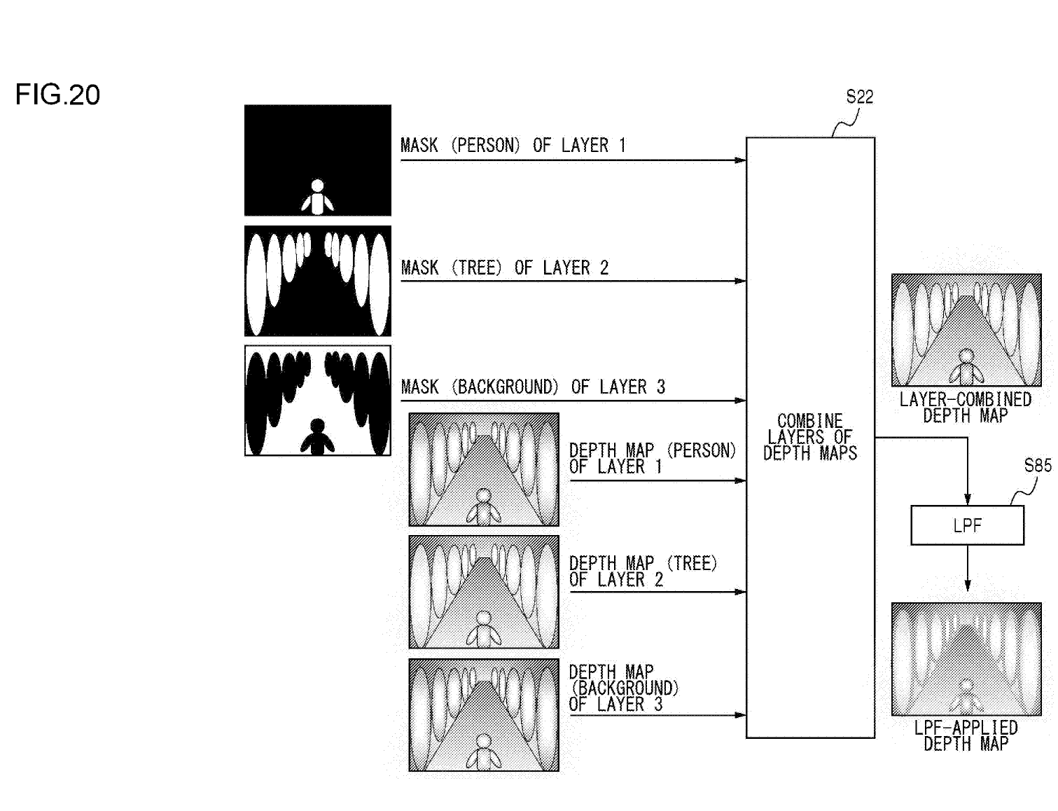

FIG. 20 is a diagram illustrating overall process procedures of an image editing system 500 according to a modified example of the first exemplary embodiment of the present invention. The process procedures of FIG. 20 include a low-pass filtering process added to the process procedures of FIG. 4. Hereinafter, a difference therebetween will be described. The mask blurring process is not added unlike in the process procedures of FIG. 14.

The depth map processing unit 20 applies a low-pass filter to a combined depth map (S85). Thereby, a variation in a depth value of an object boundary in a depth map is smoothened. However, a variation in a depth value cannot be randomly adjusted as compared with the method of using the blurring mask. In addition, in the method of using the blurring mask, only a variation in a depth value of the object boundary can be processed so as to be smoothened. In contrast, in the method of applying a low-pass filter to a combined depth map, fine details (unevenness) disappear in a flat part inside an object as well as in the object boundary.

The method of using the blurring mask and the process of applying a low-pass filter to a combined depth map may be used independently, or both of them may be used together. In addition, an order of the processes may be changed. A low-pass filter may be applied to depth maps before layer combination so as to generate layer depth maps having undergone the blurring process, the layer depth maps may be combined using the blurring mask, and the low-pass filter may be further applied to the combined depth map.

Next, a second exemplary embodiment will be described. In the first exemplary embodiment, the following processes are performed on a mask which is used as a reference when a depth map is processed. The area of a valid region of the mask is varied. A slant is given to an edge part of the mask (specifically, 0 or 1 is not made but an intermediate value such as 0.5 is made). Depth maps are combined through a-blending according to the slant (the intermediate value) given to the mask. A low-pass filter is applied to the combined depth map so as to suppress a rapid variation.

In the first exemplary embodiment, a description has been made of a case where an object boundary part of the combined depth map has continuity through these processes, and awkwardness of the object boundary part of an image (a 3D image) generated based on the combined depth map is not visible.

In the method according to the first exemplary embodiment, there is an occurrence of a case where a part which is not originally required to be corrected is corrected. There are cases where an image is awkwardly varied due to side effects of the correction. In addition, when an effect of the correction is weakened in order to prevent or reduce the side effects of the correction, awkwardness of an object boundary part may not be completely removed.

In the second exemplary embodiment, means for achieving an effect that a mask correcting process is asymmetrical locally is studied in consideration of the particularity of the mask blurring process. Thereby, a correcting process can be performed exclusively only on an aimed part, and thus it is possible to prevent or reduce the above-described side effects. In other words, a mask edge part is processed asymmetrically, and a mask having an asymmetrical edge is processed. Thereby, while suppressing side effects of the correcting process, awkwardness of an object boundary part in a generated 3D image can be hardly visible.

In light of the particularity of the mask blurring process, first, the reason for an aimed effect being achieved by processing a mask asymmetrically will be described, and, next, detailed means for processing the mask asymmetrically will be described.

First, the reason for an aimed effect being achieved by processing a mask asymmetrically will be described. As described above, in the present specification, some pixels of an input image are shifted horizontally based on a depth value expressed by a depth map so as to generate a 3D image which has parallax for each object with respect to the input image. Generally, in a case where the input image is used as a left eye image, and a right eye image is generated by shifting pixels, the pixels are shifted to the left in order to give parallax in a protrusion direction. In this case, an omitted pixel region occurs on the right side of a shifted object due to the pixel shift. On the other hand, the shifted pixels cover background pixels on the left side of the shifted object. Omitted pixels do not occur on the left side of the object.

In other words, the pixel omission due to the pixel shift occurs on only one side of an object. A direction in which the pixel omission occurs depends on two facts, that is, whether or not an image to be generated is a right eye image or a left eye image and whether parallax in a protrusion direction or parallax in a depth direction is given to an object.

In the above-described example, if a mask edge is processed equally on both of left and right sides of an object, awkwardness of the boundary part is made to be invisible on the right side of the object. On the other hand, in a case where there is a certain texture in a background part corresponding to the left side of the object, pixel shift influenced by the processing of the mask edge also influences the background part. In this case, the background texture may possibly be distorted. For example, in a case where the background texture includes a white line of a road, the white line may possibly be distorted.

Therefore, the above-described processing of the mask edge is performed only on the right side of the object and is not performed on the left side thereof. Thereby, a background texture on the left side of the object can be made not to be distorted.

Next, detailed means for processing the mask asymmetrically will be described. As described in the first exemplary embodiment, the following two filters are used to process the edge of the mask. One is a filter used for varying the area of a valid region of a mask by moving an edge position of the mask. The other is a filter for giving a slant to the mask edge in order to control a blending ratio of depth maps corresponding to the mask. The former corresponds to the first low-pass filter 81 of FIG. 16, and the latter corresponds to the second low-pass filter 83.

This filter generally has coefficients which are horizontally or vertically symmetrical. According to the second exemplary embodiment, a filter in which coefficients which are asymmetrical with respect to the center are set is intentionally used. Thereby, the mask edge can be processed horizontally asymmetrically, and thus it is possible to prevent or reduce side effects of the above-described correcting process.

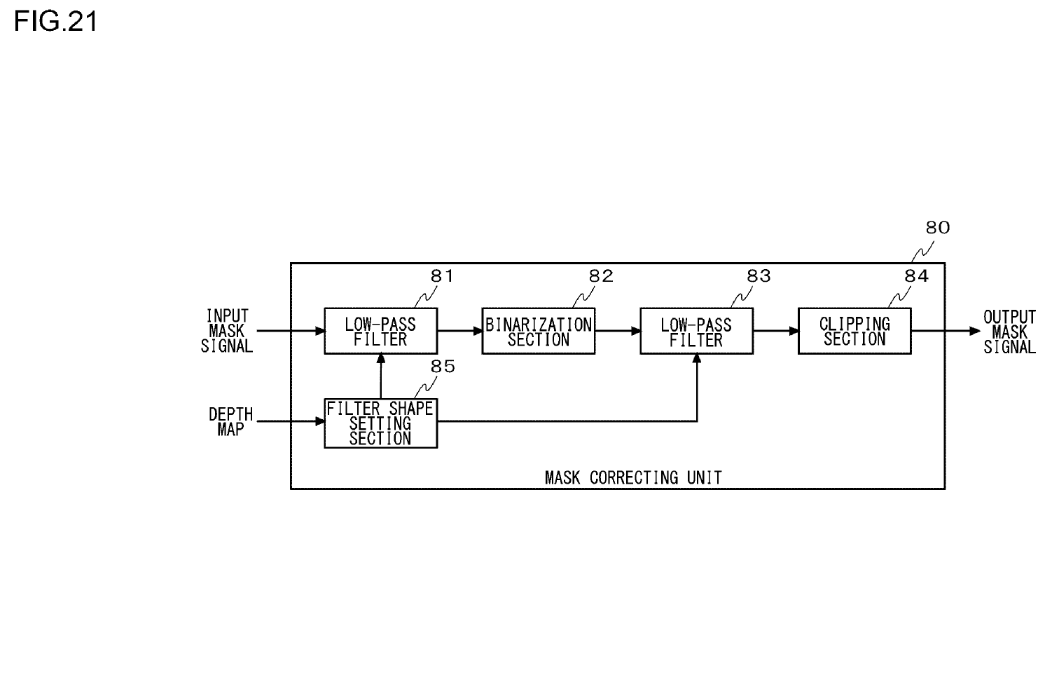

FIG. 21 is a diagram illustrating a configuration example of the mask correcting unit 80 according to the second exemplary embodiment. The mask correcting unit 80 according to the second exemplary embodiment has a configuration in which a filter shape setting section 85 is added to the mask correcting unit 80 of FIG. 16. Hereinafter, a description will be made of a difference from the mask correcting unit 80 of FIG. 16.

The mask correcting unit 80 according to the second exemplary embodiment performs a blurring process on an object boundary part of a mask using the second low-pass filter 83 which is at least horizontally asymmetrical. The filter shape setting section 85 sets a filter shape of the second low-pass filter 83. A user can set information for specifying a filter shape of the second low-pass filter 83 in the filter shape setting section 85 from the operation unit 60. The user sets the number of taps and/or a value of a coefficient of the second low-pass filter 83 to be horizontally asymmetrical, thereby setting the second low-pass filter 83 with a filter shape which is horizontally asymmetrical.

In addition, as described above, a two-dimensional low-pass filter may be used to perform the blurring process not only in the horizontal direction but also in the vertical direction. In this case, the user may set the second low-pass filter 83 with a filter shape which is horizontally and vertically asymmetrical. Further, as described above, if an elliptical two-dimensional low-pass filter is used, a natural blurring process can also be performed in a slant direction.

In this way, the user can set the second low-pass filter 83 which has separate coefficients in the horizontal direction, in the vertical direction, and in the slant direction, and has a coefficient which is asymmetrical with respect to the center. In other words, it is possible to set the second low-pass filter 83 with a shape which is asymmetrical horizontally, vertically, and diagonally in all directions. In this way, the user can make the effect of the blurring process randomly act on any of vertical, horizontal and diagonal parts of a target object.

Hereinafter, an effect of a case where the second low-pass filter 83 is horizontally asymmetrical will be examined. For better understanding of description of the examination, a one-dimensional low-pass filter which performs a blurring process in the horizontal direction is assumed.

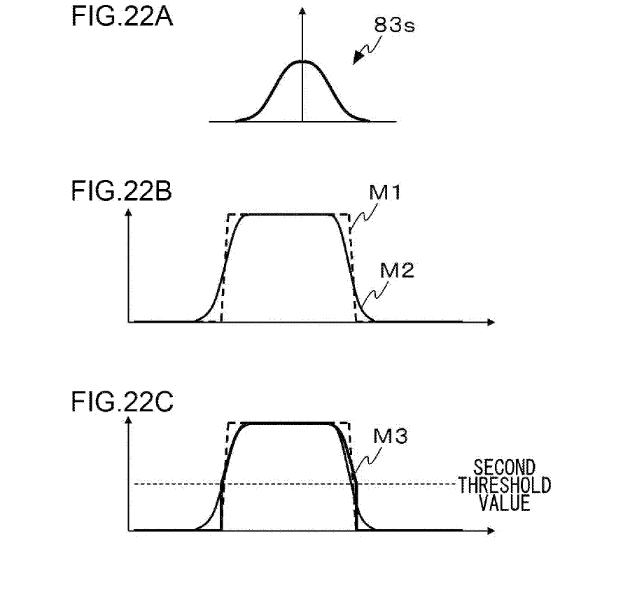

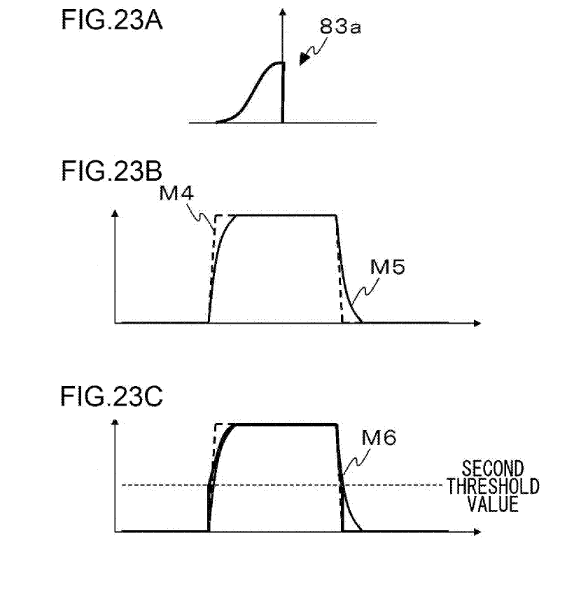

FIGS. 22A to 22C are diagrams illustrating a processing process of a mask edge using a second low-pass filter 83s which is horizontally symmetrical. FIGS. 23A to 23C are diagrams illustrating a processing process of a mask edge using a second low-pass filter 83a which is horizontally asymmetrical. FIG. 22A illustrates an example of the second low-pass filter 83s which is horizontally symmetrical. FIG. 23A illustrates an example of the second low-pass filter 83a which is horizontally asymmetrical.

FIG. 22B illustrates a process of filtering a mask M1 (the dotted line) using the second low-pass filter 83s of FIG. 22A which is horizontally symmetrical. A filtered mask M2 (the solid line) has left and right edges which are equal and smooth. FIG. 23B illustrates a process of filtering a mask M4 (the dotted line) using the second low-pass filter 83a of FIG. 23A which is horizontally symmetrical. A filtered mask M5 (the solid line) has left and right edge shapes which are different. A high level region of the left edge is blunt gently. A low level region of the right edge gently extends outward.

As illustrated in FIG. 17, the mask filtered by the second low-pass filter 83 is clipped using the second threshold value. In the clipping process, a mask value of a level lower than the second threshold value is set to zero. The second threshold value is set around an intermediate level of the mask level.

FIG. 22C illustrates a process of clipping the filtered mask (the thin solid line) of FIG. 22B with the second threshold value. In a mask M3 (the thick solid line) after being clipped, low level regions of the left and right edges are vertical. FIG. 23C illustrates a process of clipping the filtered mask (the thin solid line) of FIG. 23B with the second threshold value. In a mask M6 after being clipped, low level regions of the left and right edges are also vertical.

Upon comparison of the mask M3 with the mask M6, the former has the same slant in the left and right edges. The latter has different slants in the left and right edges. As illustrated in FIG. 23A, in a case of using the second low-pass filter 83a which has a coefficient only in the left side with respect to the center, a slant is given to the left edge, but a slant is not given to the right edge for the most part. The right edge maintains an edge in a steep state, which is approximately the same as the state before being processed.

As illustrated in FIG. 23B, a gentle slant is given to the low level region in the right edge of the mask M5 filtered by the asymmetrical second low-pass filter 83a. Then, as illustrated in FIG. 23C, the mask M5 is compared with the second threshold value, and a mask value of a level lower than the second threshold value is clipped to zero. Thereby, the slant of the low level region in the right edge of the mask M6 after being clipped is removed.

If the clipping process is not performed, even though an edge shape of the mask can be made to be horizontally asymmetrical, the slant of the low level region of the mask level remains. The aim of the mask edge processing process according to the second exemplary embodiment cannot be achieved. In other words, the effect cannot be achieved in which horizontally asymmetrical blending of layer depths, further, a range influenced by pixel shift when 3D images are generated is limited, and thereby the mask edge processing process does not influence a background part where there is a texture.

In contrast, the above-described clipping process is added thereto, and thereby a processing is possible in which a slant is given to only one edge of a mask and a slant is not given to the other edge. Therefore, the clipping process according to the second exemplary embodiment achieves an advantageous effect which cannot be easily derived from a mere processing process in which a mask edge shape is set to be asymmetrical.

As described above, the user can set any of a filter shape of the second low-pass filter 83. Therefore, a blurring process which has a bias not in all directions of an object but in any directions can be performed. For example, the bias can be adjusted depending on circumstances of a texture around the object. In the following description, a process of setting a filter shape of the second low-pass filter 83 not manually but automatically will be described. Thereby, it is possible to reduce a work load on the user.

The description will be continued with reference to FIG. 21 again. The filter shape setting section 85 sets a filter shape of the second low-pass filter 83 according to whether an image to be generated is a right eye image or a left eye image, and an anteroposterior relationship between an object and the periphery thereof obtained from a comparison result of a depth value of inside of a boundary and a depth value of outside of the boundary in an object boundary part of a mask.

In a case where an image to be generated is a left eye image, and an object is located in front of the periphery (that is, in the protrusion direction), the 3D image generation unit 30 pixel-shifts an object to the right. In a case where an image to be generated is a left eye image, and an object is located further inward than the periphery (that is, in the depth direction), the 3D image generation unit 30 pixel-shifts an object to the left. In a case where an image to be generated is a right eye image, and an object is located in front of the periphery (that is, in the protrusion direction), the 3D image generation unit 30 pixel-shifts an object to the left. In a case where an image to be generated is a right eye image, and an object is located further inward than the periphery (that is, in the depth direction), the 3D image generation unit 30 pixel-shifts an object to the right.

In a case where the object is pixel-shifted to the right, the filter shape setting section 85 sets a filter shape in which the left edge of the second low-pass filter 83 is gentler than the right edge. The filter shape is set in which a slant is not given to the right edge, or only a very small slant is given thereto. In a case where the object is pixel-shifted to the left, the filter shape setting section 85 sets a filter shape in which the right edge of the second low-pass filter 83 is gentler than the left edge.

Hereinafter, a description thereof will be made in detail. Of a right eye image and a left eye image forming 3D images, the image editing system 500 in the present specification assigns an original input image to one and an image generated through pixel shift to the other. This assignment is determined by a user's settings. The determined assignment is set in the filter shape setting section 85.

Next, it is determined whether or not an object indicated by a mask is present in a protrusion direction or in a depth direction with respect to the periphery. In a case where the object is present in the protrusion direction, it is necessary to lengthen a distance between the object in a right eye image and the object in a left eye image. Conversely, in a case where the object is present in the depth direction, it is necessary to shorten the distance. A depth map is used to determine whether an object is present in the protrusion direction or in the depth direction with respect to the periphery.

The filter shape setting section 85 analyzes a depth map so as to obtain a relative difference between a depth value of a region of an object indicated by a mask and a depth value of the periphery thereof. For example, a difference between an average value of depth values in the region of the object and an average value of depth values in a range set in the periphery is obtained.

In the present specification, the closer to white, the higher the depth value, and, the closer to black, the lower the depth value. Therefore, if a depth value of the region of the object is larger than a depth value of the periphery, it can be determined that the object is closer to an observer than the periphery. Conversely, if a depth value of the region of the object is smaller than a depth value of the periphery, it can be determined that the object is more distant from an observer than the periphery.

A case where a depth value of a region of an object indicated by a mask is larger than a depth value of the periphery, that is, where it is determined that the object is located in the protrusion direction, is considered. In a case where an image generated through pixel shift is assigned to a right eye image in the premises thereof, it can be determined that a direction of the pixel shift is the left. In this case, an omitted pixel region occurs on the right side of the object due to the pixel shift. Therefore, a correction process is preferable in which the right side of the object is processed so as to be wider and be further given a slant, and the left side of the object is not processed. The filter shape setting section 85 sets the second low-pass filter 83 with a filter shape in which the right edge is gentler in order to realize such a correcting process.

In this way, the filter shape setting section 85 determines a direction in which a filter shape of the second low-pass filter 83 is biased based on two parameters including whether an image generated through pixel shift is a right eye image or a left eye image, and a relative difference between depth values of a region of an object and the periphery.

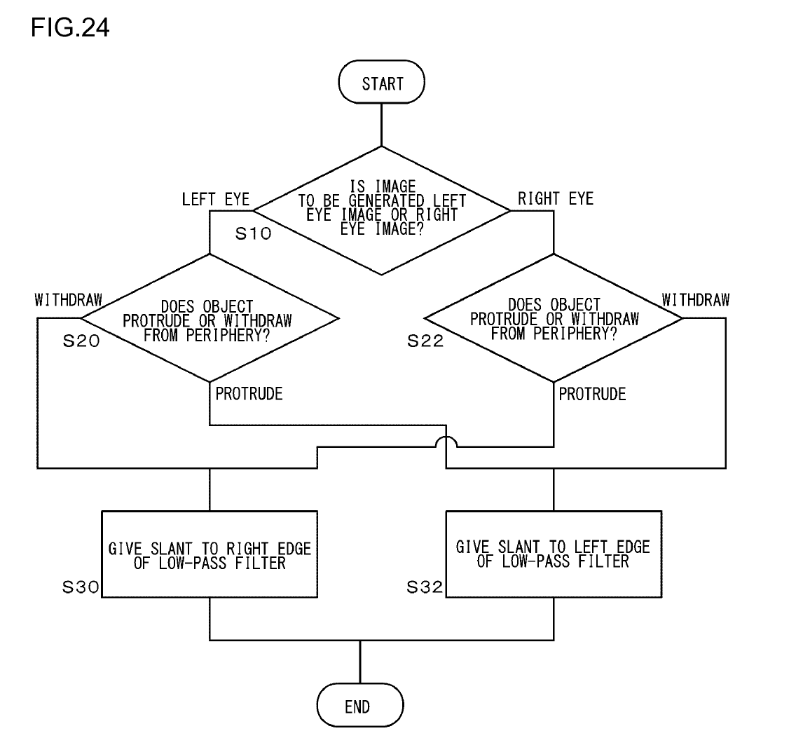

FIG. 24 is a flowchart illustrating a process of determining a filter shape with the filter shape setting section 85 according to the second exemplary embodiment. First, the filter shape setting section 85 determines whether a generated image is a right eye image or a left eye image (S10). Next, it is determined whether the object protrudes or withdraws from the periphery (S20 or S22).

If the generated image is a left eye image (the left eye in S10) and the object withdraws from the periphery (withdraw in S20), the filter shape setting section 85 determines a direction of pixel shift as the left and sets a filter shape of the second low-pass filter 83 to a filter shape in which a slant is given to the right edge (S31). If the generated image is a left eye image (the left eye in S10) and the object protrudes from the periphery (protrude in S20), the filter shape setting section 85 determines a direction of pixel shift as the right and sets a filter shape of the second low-pass filter 83 to a filter shape in which a slant is given to the left edge (S32).

If the generated image is a right eye image (the right eye in S10) and the object protrudes from the periphery (protrude in S22), the filter shape setting section 85 determines a direction of pixel shift as the left and sets a filter shape of the second low-pass filter 83 to a filter shape in which a slant is given to the right edge (S31). If the generated image is a right eye image (the right eye in S10) and the object withdraws from the periphery (withdraw in S22), the filter shape setting section 85 determines a direction of pixel shift as the right and sets a filter shape of the second low-pass filter 83 to a filter shape in which a slant is given to the left edge (S32).

In addition, the filter shape setting section 85 may determine an extent of a slant in the edge on a side (that is, a side to which a slant is to be given) which is to be gentler, according to a difference between a depth value of inside of an object boundary and a depth value of outside thereof. A large difference indicates that a step-difference of the object boundary is large and a pixel shift amount increases. The filter shape setting section 85 increases an extent of a slant as the difference gets larger. That is to say, the larger the difference is, the gentler the slant to be given to an edge is set to be.

The example in which the second low-pass filter 83 is horizontally asymmetrical has been described hitherto. In the second exemplary embodiment, not only the second low-pass filter 83 but also the first low-pass filter 81 may be horizontally asymmetrical.

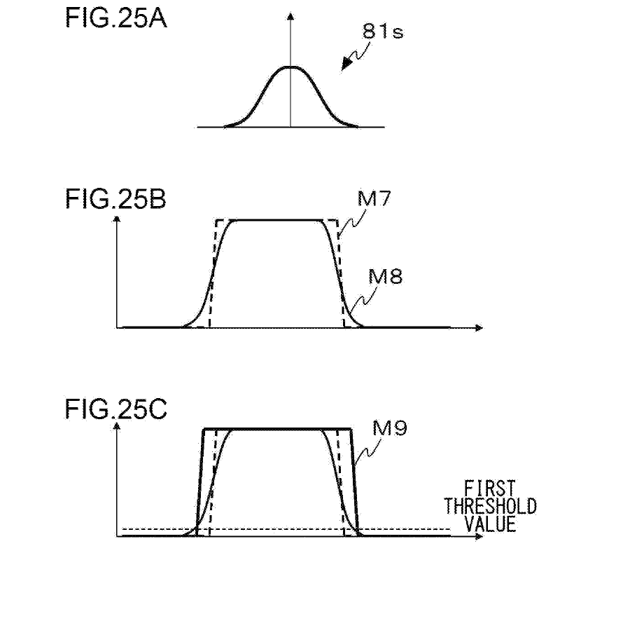

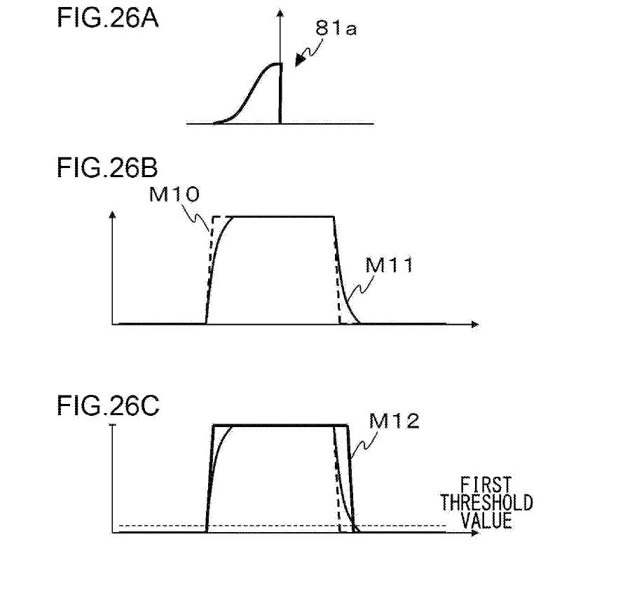

FIGS. 25A to 25C are diagrams illustrating a processing process of a mask edge using a first low-pass filter 81s which is horizontally symmetrical. FIGS. 26A to 26C are diagrams illustrating a processing process of a mask edge using a first low-pass filter 81a which is horizontally asymmetrical. FIG. 25A illustrates an example of the first low-pass filter 81s which is horizontally symmetrical. FIG. 26A illustrates an example of the first low-pass filter 81a which is horizontally asymmetrical.

FIG. 25B illustrates a process of filtering a mask M7 (the dotted line) using the first low-pass filter 81s of FIG. 25A which is horizontally symmetrical. A filtered mask M8 (the solid line) has left and right edges which are the same and gentle. FIG. 26B illustrates a process of filtering a mask M10 (the dotted line) using the first low-pass filter 81a of FIG. 26A which is horizontally symmetrical. A filtered mask M11 (the solid line) has left and right edge shapes which are different. A high level region of the left edge is blunt gently. A low level region of the right edge gently extends outward.

FIG. 25C illustrates a processing process of increasing a mask edge width by binarizing the filtered mask (the thin solid line) of FIG. 25B with the first threshold value (refer to FIG. 17). In a case of increasing the edge width, the first threshold value is set around zero. FIG. 26C illustrates a processing process of increasing a mask edge width by binarizing the filtered mask (the thin solid line) of FIG. 26B with the first threshold value.

As illustrated in FIG. 25C, a mask M9 after being processed has the left and right edges which equally extend. On the other hand, as illustrated in FIG. 26C, the mask M12 after being processed has the left and right edges of which a movement amount is different. In a case of using the first low-pass filter 81a which has a coefficient on only the left side with respect to the center, as illustrated in FIG. 26C, the right edge position is moved to the right, but the left edge position remains in an original position. As above, the left and right sides of the mask can be widened unequally.

In a case of giving a slant to the mask edge, an object boundary part is widened. In this case, if the edge position of the mask is left as it is, the object boundary part goes toward inside of the object. Therefore, in a case of giving a slant to the edge, typically, the edge position is moved outward. The larger the extent of a slant is, the further outward the edge position is moved. As above, an extent of the slant and a movement amount of the edge position have a proportional relationship.

As illustrated in FIGS. 23A to 23C and FIGS. 26A to 26C, in the low-pass filter with a filter shape which has a coefficient on the left side, the left edge slants, and the right edge position is moved outward. Therefore, the first low-pass filter 81 and the second low-pass filter 83 are required to be set to filter shapes which are horizontally opposite to each other. In a case where the left side of the object is desired to be blurred, the second low-pass filter 83 which has a coefficient on the left side is set, and the first low-pass filter 81 which has a coefficient on the right side is set. Conversely, in a case where the right side of the object is desired to be blurred, the second low-pass filter 83 which has a coefficient on the right side is set, and the first low-pass filter 81 which has a coefficient on the left side is set.

The example illustrated in FIGS. 26A to 26C is an example of the case where the edge position of the mask is moved outward (that, the width of the mask increases) using the first low-pass filter 81. In a case of increasing the width of the mask, there is a use of the first low-pass filter 81 with a filter shape which has a coefficient on an opposite side to an edge side which is moved outward. Conversely, in a case of moving the edge position of the mask inward (that is, the width of the mask decreases), there is a use of the first low-pass filter 81 with a filter shape which has a coefficient on the same side as an edge side which is moved inward.

FIG. 26A illustrates the first low-pass filter 81a with a filter shape which has a coefficient on only the left side. FIG. 26B illustrates the mask M11 which has been filtered by the first low-pass filter 81a. On the left side of the mask M11, a slant is given to inside, and, on the right side thereof, a slant is given to outside.

In a case of increasing the width of the original mask M10, a level of the first threshold value is set to be low. If the filtered mask M11 is binarized with the first threshold value, the right edge in which the slant is given to the outside of the original mask M10 is moved outward, and thus the width of the original mask M10 grows to the right (refer to FIG. 42C). The left side does not vary. Conversely, in a case of decreasing the width of the original mask M10, a level of the first threshold value is set to be high. If the filtered mask M11 is binarized with the first threshold value, the left edge in which the slant is given to the inside of the original mask M10 is moved inward, and thus the left side of the original mask M10 is reduced. The right side does not vary. In this way, in a case of increasing the width of the mask, an opposite side to a side having a coefficient of the first low-pass filter 81 is widened, and, in a case of decreasing the width of the mask, the same side as a side having a coefficient of the first low-pass filter 81 is narrowed.

In the description hitherto, the description has been made of the method in which the entire mask is processed in the same way using a single filter defined by a unique coefficient when processing an edge. This is not necessarily limited to the process of using a single filter in order to achieve an effect of performing the processing of a mask edge described hitherto in an asymmetrical manner. A filtering process may be performed individually for each region of a mask edge by using a plurality of filters with different filter shapes. In other words, a filter with a wide shape is used for a region on which a processing of a mask is desired to be performed widely. Conversely, a filter with a narrow shape is used for a region on which an extent of a processing of a mask is desired to be reduced, or no filtering process is performed. As above, a plurality of types of low-pass filters may be changed and used for each region of a mask edge.

As described above, according to the second exemplary embodiment, the processing of a mask edge can be performed asymmetrically horizontally, vertically, and diagonally in all directions. An object boundary part is corrected using such a mask, and thereby only a distorted part can be exclusively corrected without influencing a normal background texture. Therefore, it is possible to generate high definition 3D images.

Next, an explanation will be given on a third exemplary embodiment. By using the method explained in the first and second exemplary embodiments, a distortion occurred in an omitted pixel part can be reduced. With the 2D-3D conversion by the pixel shift described above, there is a problem other than the occurrence of an omitted pixel part. A detailed explanation thereon will be given below.

In case that there are a background object and a foreground object in an image, in order to add parallax to this image, the foreground object is shifted horizontally in accordance with a depth level. In order to add parallax to the foreground object in a direction in which the object protrudes, the pixels of the foreground object is moved to the left in each exemplary embodiment. As a result, an omitted pixel occurs on the outside of the right edge of the foreground object, and at the opposite left edge part, original pixels of the background image are covered.

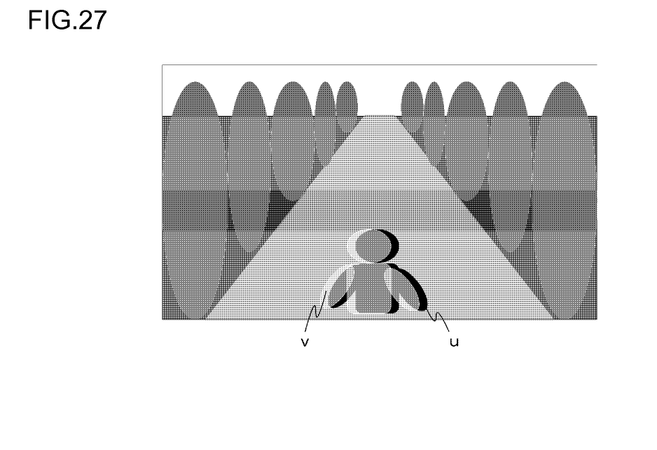

FIG. 27 shows a foreground object before and after a pixel shift. The person in the center of FIG. 27 is defined as a foreground object. The black portion in FIG. 27 indicates a position of the foreground object before the pixel shift and a translucent image of a person indicates a position of the foreground object after the pixel shift. As obvious from FIG. 27, an omitted pixel occurs at a right edge part of the foreground object (cf. reference symbol u), and at the left edge part, original pixels of the background image are covered (cf. reference symbol v).

The omitted pixel part, which is the right edge part of the object in FIG. 27, can be interpolated by using surrounding pixels while reducing distortion by the method described in the first and second exemplary embodiments. However, the left edge part of the object in FIG. 27, where the background image is covered by the foreground image, original background pixels are overwritten by post-shift foreground pixels. Therefore, at an edge boundary part of the object, the foreground and the background are separated clearly, which results in an image with a sharp outline.

Generally, in an image produced artificially, such as CG or the like, an edge boundary of an object is usually clear. However, in a natural image captured by a camera or the like, an edge part of an object has a soft texture varying smoothly. This is one of the factors that throw off naturalness of an image.

However, by a pixel shift, an edge part, which was soft originally, is processed into a state where an outline is sharp as described above. Therefore, a natural texture of an original image is destroyed. This is a problem for the 2D-3D conversion by a pixel shift method.

According to the third exemplary embodiment, by adding a scheme to the processing of pixel shift, a problem that an outline of an image is processed unnaturally is solved, without drastically changing a system. According to the third exemplary embodiment, foreground pixels do not completely overwrite background pixels when shifting pixels but a foreground and a background are alpha-blended in a certain ratio.

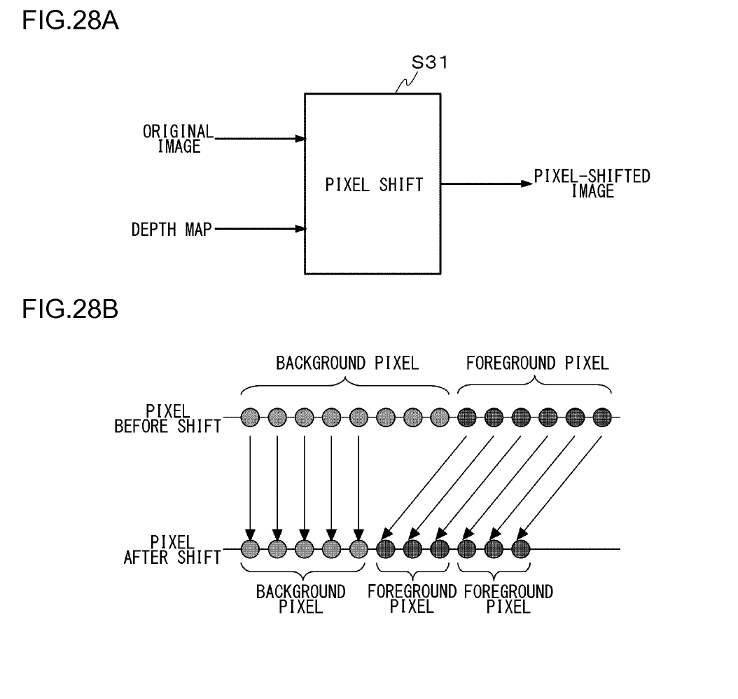

FIGS. 28A and 28B are diagrams for illustrating generation of 3D images using a pixel shift according to a common method. As shown in FIG. 28A, with a common method, a 3D image generation unit 30 shifts pixels of an original image by using a depth map (S31). As shown in FIG. 28B, with a common method, pixels are shifted so that foreground pixels cover background pixels. That is, pixels are shifted so that the foreground pixels replaces the background pixels. In FIG. 28B, foreground pixels are shifted to the left by three pixels, and three pixels at the right side of background pixels are completely overwritten by the three pixels at the left side of the foreground pixels. Therefore, the edge boundary of the foreground object is completely separated from the background.

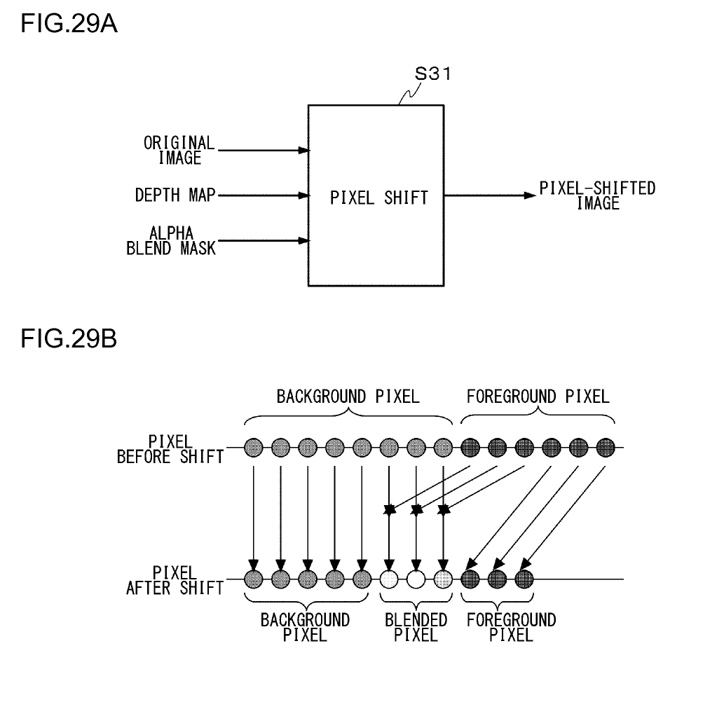

FIGS. 29A and 29B are diagrams for illustrating generation of 3D images using a pixel shift according to the third exemplary embodiment. As shown in FIG. 29A, in the third exemplary embodiment, a 3D image generation unit 30 shifts pixels of an original image by using a depth map and an alpha-blend mask (herein after referred to merely as a “blend mask”) (S31). The blend mask is a signal giving a ratio used when blending a foreground pixel and a background pixel in a pixel shift process. By setting this signal appropriately so as to alpha-blend only a part where a foreground image covers a background image, foreground pixels and background pixels in the part can conform to each other. As a result, an outline of an image is avoided from being processed unnaturally. In FIG. 29B, foreground pixels are shifted to the left by three pixels. However, the three pixels at the left side of the foreground pixels are blended with the three pixels at the right side of the background pixels. Therefore, the edge boundary part of the foreground object is blended with the background, and varies smoothly.

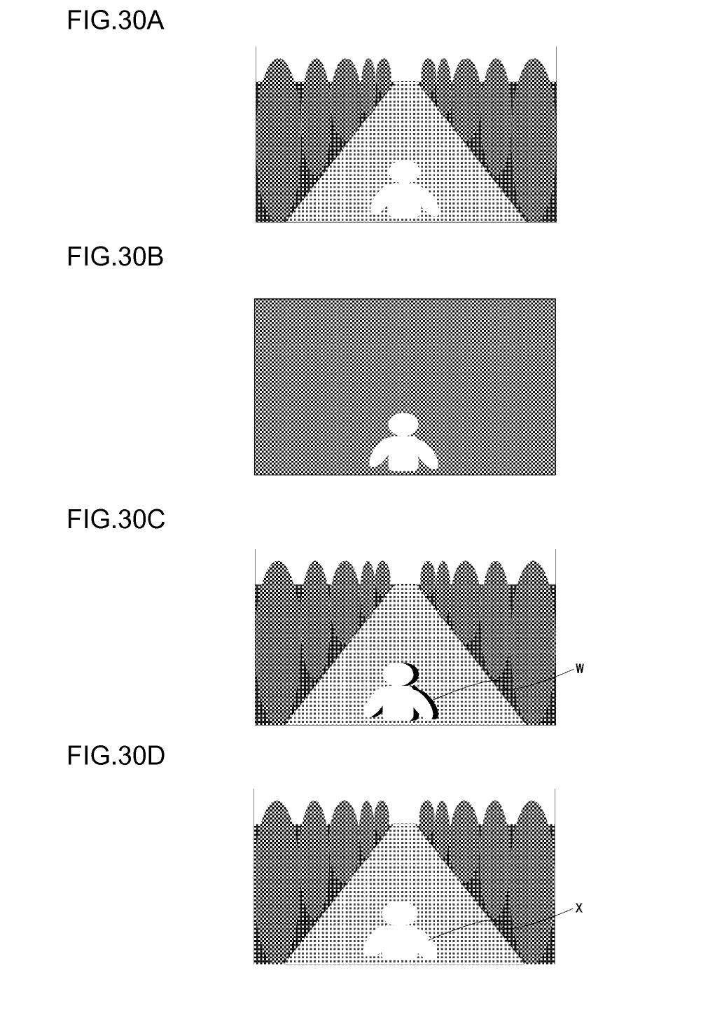

An explanation will be given on processing of an object edge in a pixel shift according to the first, the second, and the third exemplary embodiments. FIGS. 30A, 30B, 30C, and 30D are diagrams for illustrating basic processing of an object edge in a pixel shift. FIG. 30A is an original image before a pixel shift. FIG. 30B is a depth map indicating an amount of parallax to be given to the original image of FIG. 30A. In this depth map, a portion with a high luminance (a bright portion) indicates parallax in a direction in which the object protrudes.

FIG. 30C is a pixel-shifted image before interpolating an omitted pixel. This pixel-shifted image is obtained by shifting pixels of the original image of FIG. 30A in accordance with the amount of parallax of the depth map of FIG. 30B. In this figure, a person-shaped portion at the middle bottom is the foreground image. As obvious from FIG. 30C, omitted pixels occur at the right edge part (cf. reference symbol w) of the foreground image by a pixel shift.

FIG. 30D is a pixel-shifted image after the interpolation of the omitted pixels. This pixel-shifted image is a pixel-shifted image in case that the omitted pixel part is interpolated by the surrounding pixels uniformly without any special measures for a depth map. As obvious from FIG. 30D, the right edge part (cf. reference symbol x) of the foreground image is enlarged, which results in an unnatural image.

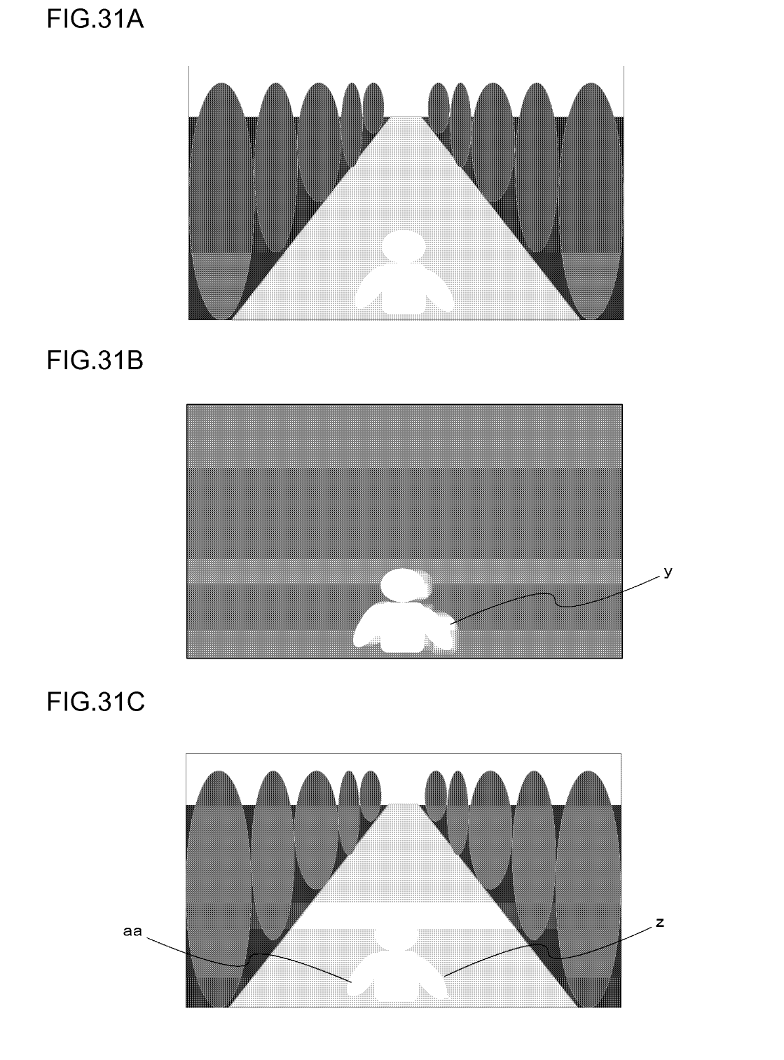

FIGS. 31A, 31B, and 31C are diagrams for illustrating processing of an object edge in a pixel shift according to the first and the second exemplary embodiments. FIG. 31A is an original image before a pixel shift. FIG. 31B is a depth map indicating an amount of parallax to be given to the original image of FIG. 31A. This depth map is, as explained according to the first and second exemplary embodiments, a depth map where a slant is added to the right edge part (cf. reference symbol y) by a process of blurring a mask signal.

FIG. 31C is a pixel-shifted image. This pixel-shifted image is obtained by shifting pixels of the original image of FIG. 31A by using the depth map of FIG. 31B. A distortion of the edge is dissolved because of the smooth variation from the background to the foreground with respect to the right edge part (cf. reference symbol z) of the object. Since the edge becomes soft, a natural image is obtained. On the other hand, with respect to the left edge part (cf. reference symbol aa) of the object, foreground pixels cover background pixels by the pixel shift. Since the edge becomes sharp, the image becomes unnatural.

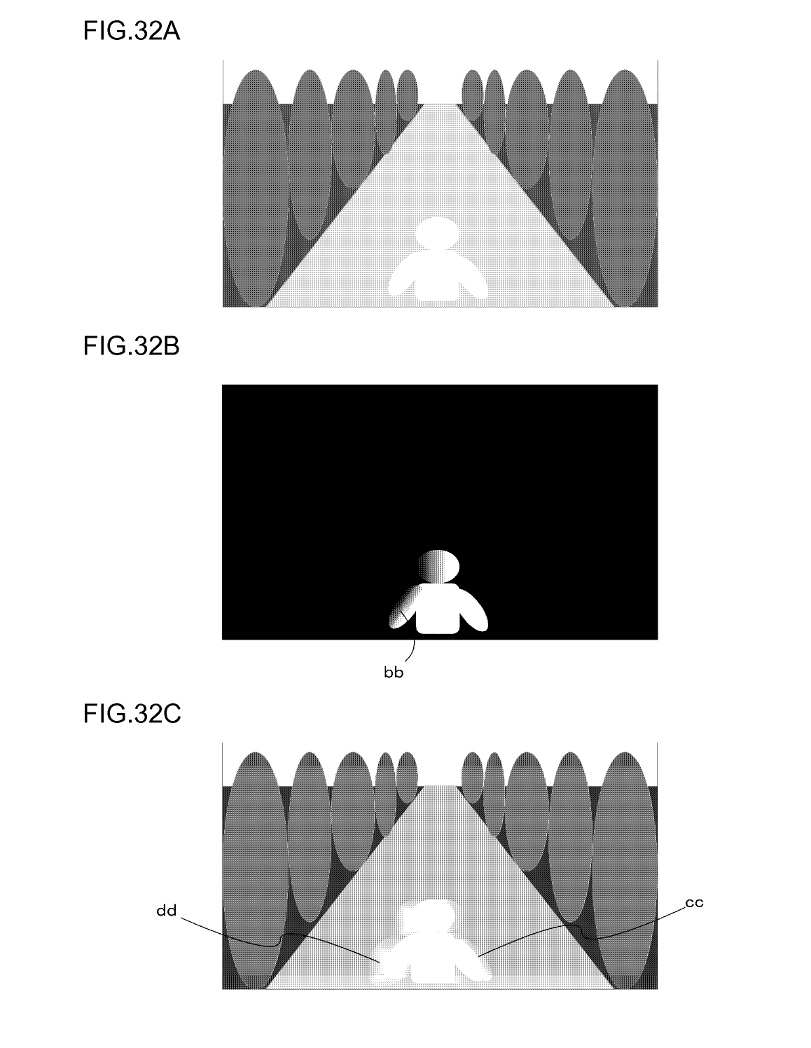

FIGS. 32A, 32B, and 32C are diagrams for illustrating processing of an object edge in a pixel shift according to the third exemplary embodiment. FIG. 32A is an original image before a pixel shift. Although not shown in the figures, a depth map used for the pixel shift is a map where a slant is added to the right edge part of the object by a process of blurring of a mask signal in a similar manner to that shown in FIG. 31B.

FIG. 32B shows a blend mask that gives a ratio used when blending a foreground pixel and a background pixel in a pixel shift process. The blend mask indicates that the higher the luminance is, the higher the blending ratio of a foreground becomes. If the blend mask is black, the background covers 100 percent, if the blend mask is white, the foreground covers 100 percent, and if the blend mask is 50 percent gray, the foreground and the background are blended half and half. In FIG. 32B, a slant is given to the luminance of the left edge part (cf. reference symbol bb) of the person object and the mask is processed so that the left edge part varies from white to black smoothly.

FIG. 32C is a pixel-shifted image. This pixel-shifted image is obtained by shifting pixels of the original image of FIG. 32A by using the depth map of FIG. 31B and the blend mask of FIG. 32B. The right edge part (cf. reference symbol cc) of the person object is same as that of the FIG. 31C. At the left edge part (cf. reference symbol dd) of the person object, one or more pixels that is shifted to the left in accordance with a level indicated by the depth map is blended with one or more background pixels that was originally at the position in accordance with a level indicated by the blend mask. Therefore, in the left edge part of the foreground object after the shift is merged into and conforms to the background part. Thus the outline becomes soft, and a natural image is obtained.

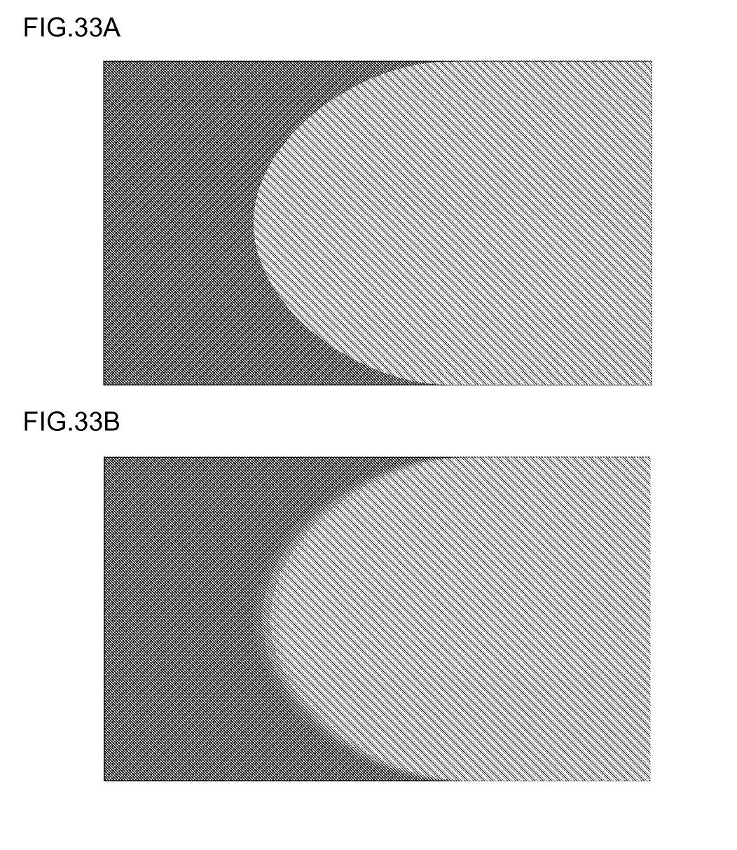

FIGS. 33A and 33B show images schematically indicating a process of alpha-blending a foreground image and a background image. FIG. 33A shows an image in case of not alpha-blending, and the left thick area indicates a background and the right pale area indicates a foreground. In FIG. 33A, the boundary separates the foreground image and the background image clearly. FIG. 33B shows an image in case of alpha-blending, and the edge of the foreground image is merged into the background image, and the outline becomes soft.

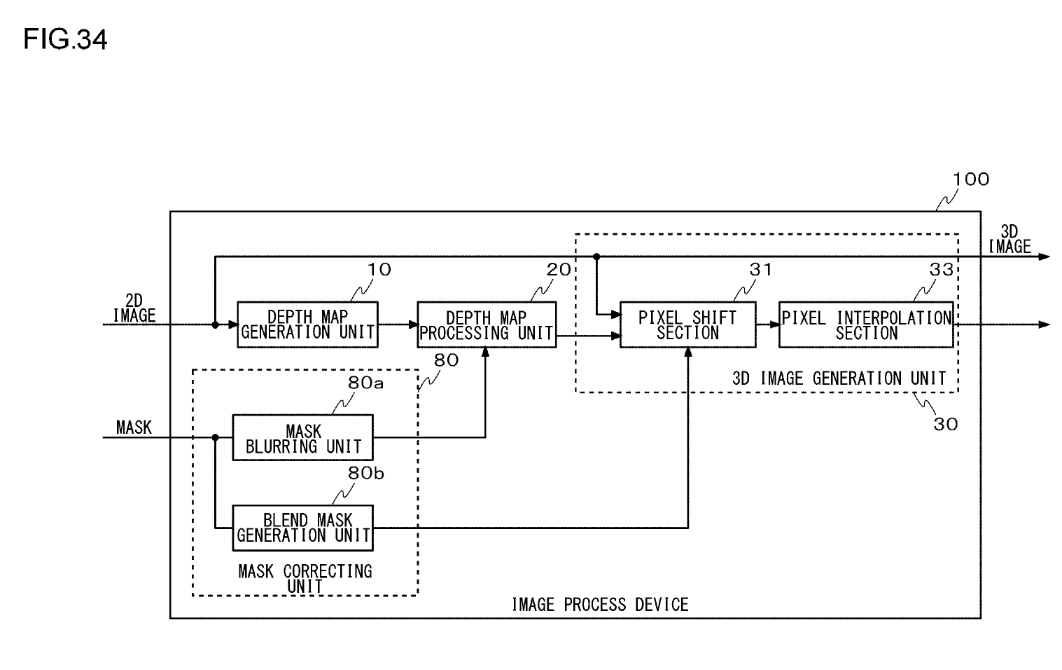

FIG. 34 shows a configuration of the image process device 100 according to the third exemplary embodiment of the invention. In order to simplify the figure, the operation reception unit 40 and the control unit 50 are omitted in FIG. 34. The depth map generation unit 10 generates a depth map of a 2D input image, which is an original image, on the basis of the 2D input image and on the basis of the depth model described above. A concrete process of generating a depth map is as described above.

On the basis of a mask and a parameter that are defined externally, the mask correcting unit 80 adds a slant to the edge opposite to the direction of shifting of an object in the mask so as to generate a blurring mask, and adds a slant to the edge in the direction of shifting of the object in the mask so as to generate a blend mask. As a mask defined externally, a ROTO mask, in which an outline of an object in an original image is traced, can be used. As described above, a mask is defined for each individual object respectively, or one mask including all objects may be defined.

A more concrete explanation will be given below. The mask correcting unit 80 includes a mask blurring unit 80a and a blend mask generation unit 80b. As the mask blurring unit 80a, the configuration of the mask correcting unit 80 shown in FIG. 16 or FIG. 21 can be used. The mask blurring unit 80a generates a blurring mask. A user can apply arbitrary blurring to an edge of an object in a mask by adjusting as parameters filter characteristics such as the number of taps and/or a coefficient of the first low-pass filter 81 and/or the second low-pass filter 83, the first threshold value of the binarization section 82, and/or the second threshold value of the clipping section 84 through the operation reception unit 40. For example, a blurring width and/or an angle of a slant can be adjusted.

In the following explanation, the configuration shown in FIG. 21, with which a horizontally asymmetrical filter shape can be set, is assumed to be adopted as the mask blurring unit 80a. The user defines a parameter so as to blur an object edge on the side where an omitted pixel occurs by a movement of an object due to a pixel shift.

As the blend mask generation unit 80b, the configuration shown in FIG. 21 can be used, and the blend mask generation unit 80b generates a blend mask. The user defines a parameter so as to blur an object edge on the side where pixels are superimposed by a movement of an object due to a pixel shift.

The mask blurring unit 80a and the blend mask generation unit 80b may respectively comprise a circuit of the configuration shown in FIG. 21 separately, or may use one circuit with time-sharing. Alternatively, the circuit may be implemented by software processing.

The depth map processing unit 20 processes the depth map generated by the depth map generation unit 10 on the basis of the blurring mask generated by the mask blurring unit 80a. Specific processing of the process is as described above.

In the third exemplary embodiment, a more detailed explanation will be given on the 3D image generation unit 30. The 3D image generation unit 30 includes a pixel shift section 31 and a pixel interpolation section 33. The pixel shift section 31 generates an image from a different viewpoint by shifting one or more pixels of a 2D input image on the basis of the depth map processed by the depth map processing unit 20. More specifically, the pixel shift section 31 shifts pixels in a 2D input image so as to generate an image having a predetermined parallax from the 2D input image. In this process, the pixel shift section 31 alpha-blends pixels of an object that is moved by the pixel shift and pixels that are covered by the moved pixels on the basis of the blend mask generated by the blend mask generation unit 80b. That is, the pixel shift section 31 generates pixels in a region, where foreground pixels that are pixels of an object and background pixels are superimposed, by alpha-blending the foreground pixels and the background pixels.

In this manner, the pixel shift section 31 has a function of blending pixels subject to a shift and pixels having existed originally at the position of a shift destination in accordance with a level of a blend mask so as to generate a new shifted pixel, in addition to the original function of shifting pixels horizontally in accordance with a level of a depth map.

A more concrete explanation on the pixel blending process will be given below. If the pixel value of a pixel subject to a shift (i.e., a foreground pixel) is set to Sf, the pixel value of a pixel having existed originally at the position of a shift destination (i.e., a background pixel) is set to Sb, and the level of a blend mask at the position of the pixel subject to a shift before the shift is set to M(0.0-1.0), the pixel value Sa of a pixel generated by the alpha-blending is represented by the following equation 1.

Sa=Sf*M+Sb*(1.0−M) [equation 1]

The pixel interpolation section 33 interpolates an omitted pixel occurred due to the pixel shift by the pixel shift section 31 by using pixels surrounding the omitted pixel. In this manner, an image generated by the pixel shift and the pixel interpolation and an original image are combined and a 3D image is generated, accordingly.

As described above, in the process of generating from an original image an image from a different viewpoint, if a foreground image covers a background image by the pixel shift, the edge boundary part of an object becomes sharp, which results in an artificiality of an image. In contrast, according to the third exemplary embodiment, by locally alpha-blending background pixels and foreground pixels so as to generate a shifted image, it is possible to soften the edge boundary part of an object and to generate a natural 3D image.

Since background pixels do not exist in the edge boundary part on the side where an omitted pixel occurs due to a pixel shift, a process of alpha-blending of a background pixel and a foreground pixel is not suitable. At the edge boundary on the side of omission, by alpha-blending layer depth maps by using a blurring mask, an amount of pixel shift of the edge boundary part is adjusted so that the edge part of an object is enlarged. This can make an omitted pixel part unnoticeable. In this manner, by applying different processes to edge boundary parts of both sides of the object with methods appropriate to respective parts, the edge boundary parts can be processed into natural edge boundary parts.

Next, an explanation will be given below on a fourth exemplary embodiment. In the third exemplary embodiment, a process for softening a certain outline at a boundary between a foreground and a background is performed in the process of a pixel shift. In comparison with a case where a similar process is performed independently, a process flow can be simplified and circuit size can be reduced. In the fourth exemplary embodiment, an explanation will be given on a method that is different from that of the third exemplary embodiment and has a similar effect as that of the third exemplary embodiment.

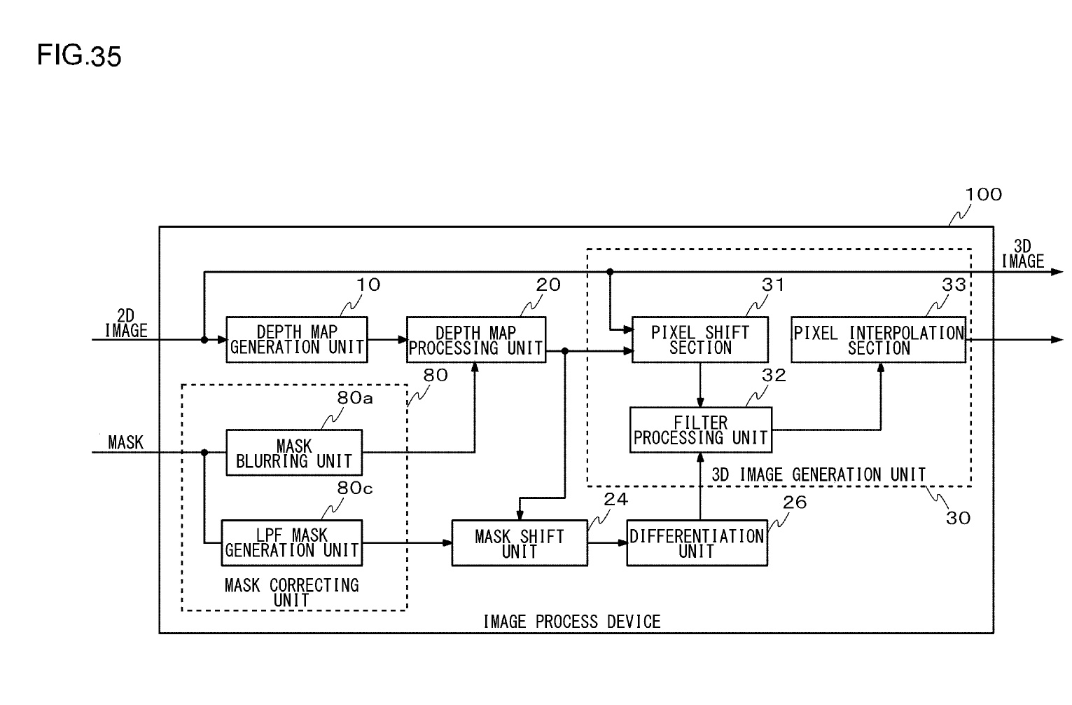

FIG. 35 shows a configuration of the image process device 100 according to the fourth exemplary embodiment of the invention. According to the fourth exemplary embodiment, the mask correcting unit 80 includes the mask blurring unit 80a and an LPF mask generation unit 80c. The configuration and the operation of the mask blurring unit 80a are similar to those described in the third exemplary embodiment. As the LPF mask generation unit 80c, the configuration shown in FIG. 21 can be used and the LPF mask generation unit 80c generates an LPF mask. The user defines a parameter so as to blur an object edge on the side where pixels are superimposed by a movement of an object due to a pixel shift. In this manner, the LPF mask generation unit 80c can be configured in a similar manner to that of the blend mask generation unit 80b according to the third exemplary embodiment.

In comparison with the image process device 100 according to the third exemplary embodiment, a mask shift unit 24 and a differentiation unit 26 are added to the image process device 100 according to the fourth exemplary embodiment. In addition, a filter processing unit 32 is added to the 3D image generation unit 30. A blend mask of the third exemplary embodiment is used for a process of blending a foreground pixel and a background pixel at the time of a pixel shift by the pixel shift section 31. In contrast, the LPF mask according to the fourth exemplary embodiment is used for a process of sharpness control of an edge by the filter processing unit 32.

The mask shift unit 24 performs a pixel shift on an LPF mask, which is generated by the LPF mask generation unit 80c, on the basis of a depth map generated by the depth map generation unit 10. As the mask shift unit 24, a circuit configuration similar to that of the pixel shift section 31 can be used. The mask shift unit 24 and the pixel shift section 31 may respectively comprise a circuit of a same configuration independently, or may use one circuit with time-sharing. Alternatively, the circuit may be implemented by software processing.

The differentiation unit 26 differentiates the shifted LPF mask, and generates an LPF mask having a value other than 0 only for an edge part that should be blurred of an object. The pixel shift section 31 generates an image from a different viewpoint by shifting one or more pixels of a 2D input image on the basis of the depth map processed by the depth map processing unit 20. The pixel shift section 31 according to the fourth exemplary embodiment only has an original function of shifting pixels horizontally in accordance with a level of a depth map, and does not have a function of alpha-blending pixels as the pixel shift section 31 of the third exemplary embodiment.

A shifted image of which an object edge on the side where pixels are superimposed is sharp is input to the filter processing unit 32 from the pixel shift section 31. The filter processing unit 32 applies a low-pass filter to this shifted image locally and selectively by using a LPF mask that is input from the differentiation unit 26. This allows blurring of the edge part of the shifted image and generation of an image with a natural object boundary. The pixel interpolation section 33 interpolates an omitted pixel occurred in the shifted image by using pixels surrounding the omitted pixel. The order of the filtering process by the filter processing unit 32 and the pixel interpolation process by the pixel interpolation section 33 may be reversed.

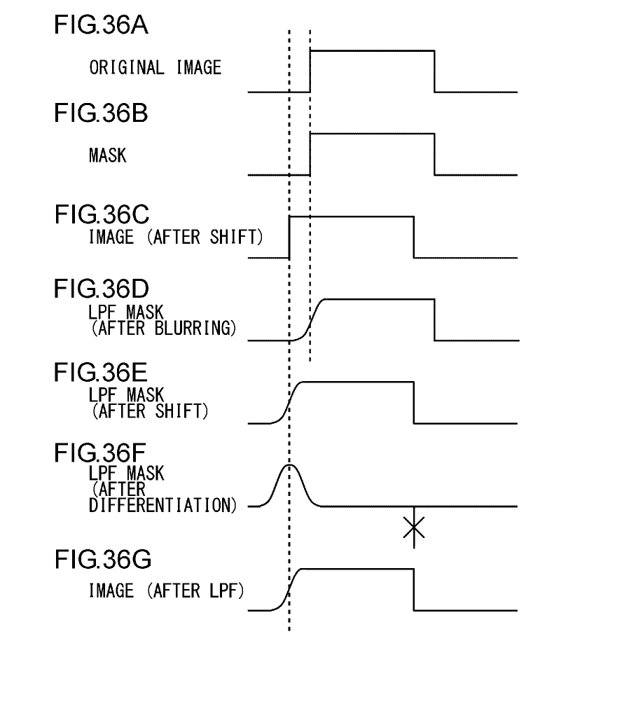

FIGS. 36A, 36B, 36C, 36D, 36E, 36F, and 36G are diagrams for illustrating a flow of generation of an image from a different viewpoint from an original image by the image process device 100 according to the fourth exemplary embodiment. FIG. 36A shows an original image. FIG. 36B shows an original mask. FIG. 36C shows an image obtained by performing a pixel shift on the original image shown in FIG. 36A by using a depth map. FIG. 36D shows a LPF mask obtained by giving a slant to an edge on the side where pixels are superimposed in the original mask shown in FIG. 36B. FIG. 36E shows a LPF mask obtained by shifting the LPF mask shown in FIG. 36D by using a depth map. FIG. 36F shows a LPF mask obtained by differentiating the LPF mask shown in FIG. 36E. FIG. 36G shows an image obtained by applying a low-pass filter to the shifted image shown in FIG. 36C by using the LPF mask shown in FIG. 36E.

In case that a result of differentiation by the differentiation unit 26 becomes negative, the resultant value is treated as 0. By the differentiation, a pixel positioned at a shifted object boundary is filtered by using a low-pass filter most intensively so that an edge boundary part of the object can be softened more.

An explanation will be given below on a specific example of the sharpness control of an object edge by the filter processing unit 32. If the level of a differentiated LPF mask is 0, the filter processing unit 32 does not perform a sharpness process. If the level of a differentiated LPF mask is higher than 0, the filter processing unit 32 performs a low-pass filtering process with different intensities in accordance with the level thereof. The “intensity” in this “low-pass filtering process with different intensities” refers to the intensity of the degree of blurring in an image after the low-pass filtering process, and any method that can control the intensity thereof can be used. Two methods will be given below as examples.

The first method is a method of controlling the number of taps of a low-pass filter. When increasing the intensity of the degree of blurring of an image, the number of taps of the low-pass filter is increased. The second method is a method of blending an image being filtered by using a low-pass filter and an image not being filtered by using a low-pass filter. When increasing the intensity of the degree of blurring of an image, the ratio of the image being filtered by using a low-pass filter is increased. Any method other than these two methods can also be used. The differentiation process by the differentiation unit 26 described above is another example. A process other than the differentiation process may also be applied to an LPF mask. Alternatively, a shifted LPF mask may be used without further processing.

According to the fourth exemplary embodiment, when using an LPF mask as a reference signal for sharpness control, a generated LPF mask is shifted horizontally by using a depth mask. A more detailed explanation will be given below on the shift of the LPF mask.

A signal that is the basis of the LPF mask is a ROTO mask. Therefore, the position of a foreground of an LPF mask generated in the LPF mask generation unit 80c is identical to the position of a foreground object in an original image, i.e., the position before a pixel shift. However, an image subject to low-pass filtering by the filter processing unit 32 is a shifted image after a pixel shift, and the position of the foreground object is shifted horizontally by the amount of parallax indicated by a depth map.

If a LPF mask generated in the LPF mask generation unit 80c is applied to a low-pass filtering process by the filter processing unit 32 without further processing, the position of a foreground object in an LPF mask and the position of a foreground object in a shifted image, which is an image subject to edge-sharpness control, do not coincide with each other. Therefore, the edge-sharpness control cannot be performed at a correct position.

Although manual generation of a new LPF mask that coincides to the position of a foreground object in a shifted image is another option, the manual generation of a new LPF mask puts a heavy load on a user. In contrast, according to the fourth exemplary embodiment, the generated LPF mask is shifted horizontally by the mask shift unit 24 so that the position of the foreground object in the LPF mask coincides with the position of the foreground object in the shifted image. The pixel shift of a LPF mask is performed on a LPF mask that already exists in a processing system by using a depth map that also already exists in the processing system. The shift process is also performed automatically by using a method similar to that used in the pixel shift section 31. A heavy load on a user such as the manual generation of a new LPF mask as described above does not occur.

Although an explanation have been given on the method of the fourth exemplary embodiment as a substitution for the method of the third exemplary embodiment, the methods according to the third exemplary embodiment and the forth exemplary embodiment may be combined and used. In either case, when performing edge-sharpness control, generation of a new control signal for the purpose of the sharpness control is not required, and the sharpness control can be performed only on the basis of a ROTO mask already existing in a system flow.

As described above, according to the fourth exemplary embodiment, by filtering an edge boundary part of an object in a shifted image, it is possible to soften the edge boundary part thereof and to generate a natural image. Since an LPF mask is also shifted by using a depth map in a similar manner to that of an original image, deterioration of quality caused by a discrepancy of edge positions between an image subject to processing and the LPF mask can be avoided.

Given above is an explanation based on the embodiments. The embodiments are intended to be illustrative only and it will be obvious to those skilled in the art that various modifications to constituting elements and processes could be developed and that such modifications are also within the scope of the present invention. For example, the direction in which to shift a foreground object may be set appropriately depending on whether an image subject to processing is a right eye image or a left eye image. In this process, for example, alpha-blending may be performed on an edge on the side where an object image covers a background image, and alpha-blending may not be performed on the side where an omitted pixel occurs, in accordance with the direction of shifting.

In the processing of a blend mask of the third exemplary embodiment and in the processing of a LPF mask of the fourth exemplary embodiment, various methods may be used, for example, a method where a blurring width is set variable, a method where the amount of blurring is set variable, a method where a position of blurring is set variable arbitrarily, a method where a position of blurring is enlarged not only horizontally but also vertically, a method where blurring is performed not by using a low-pass filter but by using a conversion table, a method where the slant of blurring is controlled, a method where a blend mask is processed manually, or a method where a blend mask is not processed at all, etc., may be used.

In a pixel shift by the pixel shift section 31 according to the first to fourth exemplary embodiments, the position of a foreground object may be shifted by using an arbitrary method other than the methods described above.

What is claimed is:

1. An image process device comprising:
a depth map generation unit configured to generate a depth map of an input image on the basis of the input image and a depth model; and
an image generation unit configured to perform a pixel shift on the input image on the basis of the depth map so as to generate an image from a different viewpoint,
wherein the image generation unit alpha-blends a pixel of an object that is moved by the pixel shift and a pixel that is covered by the pixel of the object.

2. The image process device according to claim 1, further comprising a depth map processing unit configured to process the depth map generated by the depth map generation unit on the basis of a blurring mask,
wherein the image generation unit performs the pixel shift on the input image on the bases of the depth map processed by the depth map processing unit.

3. The image process device according to claim 2,
wherein the image generation unit alpha-blends the pixel of the object that is moved by the pixel shift and the pixel that is covered by the pixel of the object on the basis of a blend mask, and
further comprising a mask correcting unit configured to add, on the basis of a mask and a parameter that are defined externally, a slant to an edge in the direction of the shift of an object in the mask so as to generate the blend mask, and to add a slant to an edge opposite to the direction of the shift of the object in the mask so as to generate the blurring mask.

4. An image process method comprising:
generating a depth map of an input image on the basis of the input image and a depth model; and
generating an image from a different viewpoint, by performing a pixel shift on the input image on the basis of the depth map,
wherein the generating of the image from a different viewpoint alpha-blends a pixel of an object that is moved by the pixel shift and a pixel that is covered by the pixel of the object.

5. A non-transitory computer-readable recording medium having embedded thereon an image process program,
the image process program comprising:
a depth-map-generation module configured to generate a depth map of an input image on the basis of the input image and a depth model; and
a different-viewpoint-image-generation module configured to perform a pixel shift on the input image on the basis of the depth map so as to generate an image from a different viewpoint,
wherein the different-viewpoint-image-generation module alpha-blends a pixel of an object that is moved by the pixel shift and a pixel that is covered by the pixel of the object.

6. An image process device comprising:
a depth map generation unit configured to generate a depth map of an input image on the basis of the input image and a depth model;
a pixel shift unit configured to perform a pixel shift on the input image on the basis of the depth map so as to generate an image from a different viewpoint;
a mask shift unit configured to perform a pixel shift on a low-pass filtering mask on the basis of the depth map; and
a filter unit configured to apply a low-pass filter to the generated image from a different viewpoint by using the shifted low-pass filtering mask.
